(19) United States
(12) Patent Application Publication
(10) Pub. No.: US 2016/0150810 A1
(43) Pub. Date: Jun. 2, 2016

(54) AQUEOUS STARCH-CONTAINING COMPOSITIONS FOR COATING FOOD PRODUCTS

(71) Applicants: Pamela HUME, Scarborough (GB); Melissa ROSE, Buckinghamshire (GB)

(72) Inventors: Pamela Hume, Scarborough (GB); Melissa Rose, Buckinghamshire (GB)

(21) Appl. No.: 14/904,241

(22) PCT Filed: Jul. 10, 2014
(86) PCT No.: PCT/IB2014/063006

§ 371 Date: Jan. 11, 2016

Related U.S. Application Data
(60) Provisional application No. 61/845,164, filed on Jul. 11, 2013.

(51) Int. Cl. A23L 1/216; A23L 1/0522

(52) U.S. Cl. CPC A23L 1/005; A23L 1/0107; A23L 1/217; A23L 1/2142; A23V 2002/00

(57) ABSTRACT

The present disclosure relates to aqueous compositions for coating food products such as French fries, comprising a hydroxypropylated, cross-linked tapioca starch which is a hydroxypropyl di-starch phosphate, and an acetylated, high amylose maize starch.

### CROSS-REFERENCE TO RELATED APPLICATIONS

The present application claims the benefit of priority from U.S. provisional application No. 61/845,164 filed on Jul. 11, 2013, the contents of which are incorporated herein by reference in their entirety.

### FIELD

The present disclosure relates to aqueous compositions for coating food products such as French fries and to fried food products such as French fries comprising a coating prepared from such aqueous compositions. The present disclosure also relates to processes for preparing fried, coated food products such as fried, coated potato articles and to fried, coated food products such as fried, coated potato articles prepared according to such processes.

### BACKGROUND

Fried, coated food products such as fried, coated potato articles and processes for the preparation thereof are known.

For example, PCT Application Publication No. 99/21444 discloses a method for producing a reheatable food product comprising a step of adjusting the water binding capacity of the coating, a coating suitable for application to such a food product and a food product coated with such a coating. A preferred coating composition comprises gelatinised starch obtainable from at least two sources, preferably potato and pea.

Melvej (U.S. Pat. No. 5,997,918) discloses starch-containing coating materials for food products such as potato strips as well as food products coated with such a material. The coating materials may include a chemically cross-linked and stabilized modified tapioca starch and a modified high amylose corn starch. However, Melvej teaches that chemically cross-linked modified corn starch is preferred over high amylose corn starch or modified high amylose corn starch for providing viscosity in the aqueous slurry and uniform structure and crispness in the finished product. The exemplary formulations contain a maximum of 1.25 wt % of modified high amylose corn starch.

Woerman et al. (U.S. Pat. No. 5,750,168) discloses aqueous starch enrobing slurries for coating the outer surface of a potato product which contain an ungelatinized cross-linked tapioca starch, processes for preparing such slurries, frozen potato products with a film-like coating on their outer surface and processes for their preparation. The coatings are taught to form a discontinuous film which is preferably somewhat brittle. While other starches such as corn starch may optionally be used in the aqueous starch enrobing slurries, Woerman et al. teaches that certain improved properties are provided in the absence of corn starch.

It would be desirable to be provided with a composition for coating food products such as potato articles and processes for preparing fried, coated food products such as fried, coated potato articles that would at least partially solve one of the problems mentioned or that would be an alternative to the known compositions for coating food products such as potato articles and processes for preparing fried, coated food products such as fried, coated potato articles.

### SUMMARY

In the present disclosure, aqueous compositions for coating food products such as potato articles, for example French fries and processes for preparing fried, coated food products such as fried, coated potato articles, for example fried, coated French fries have been developed. Food products such as fried, coated potato articles, for example fried, coated French fries have been prepared using such aqueous compositions and processes.

Accordingly, the present disclosure includes an aqueous composition for coating vegetable articles for frying, the aqueous composition comprising:
a substituted, cross-linked starch; and
a high amylose maize starch.

In an embodiment, the ratio by weight of the substituted, cross-linked starch to the high amylose maize starch on a dry weight basis is from about 60:40 to about 80:20, optionally about 70:30.

In another embodiment, the substituted, cross-linked starch is present in an amount of from about 45 wt % to about 65 wt % on a dry weight basis; the high amylose maize starch is present in an amount of from about 15 wt % to about 35 wt % on a dry weight basis; and the ratio by weight of the substituted, cross-linked starch to the high amylose maize starch on a dry weight basis is from about 60:40 to about 80:20, optionally about 70:30.

In an embodiment, the substituted, cross-linked starch is a hydroxypropylated, cross-linked starch.

In another embodiment, the substituted, cross-linked starch is an acetylated, cross-linked starch.

In an embodiment, the substituted, cross-linked starch is selected from a tapioca starch, a waxy maize starch, a maize starch and a sago starch. In another embodiment, the substituted, cross-linked starch is a tapioca starch. In a further embodiment, the substituted, cross-linked starch is a hydroxypropyl di-starch phosphate.

In an embodiment, the substituted, cross-linked starch consists essentially of a single substituted, cross-linked starch.

In another embodiment, the substituted, cross-linked starch consists essentially of a combination of two substituted, cross-linked starches, wherein each of the substituted, cross-linked starches has a different process tolerance. In another embodiment, each of the substituted, cross-linked starches is a tapioca-based hydroxypropyl di-starch phosphate.

In an embodiment, the substituted, cross-linked starch consists essentially of a first substituted, cross-linked starch having a moderate process tolerance and a second substituted, cross-linked starch that is more process tolerant than the first substituted, cross-linked starch.

In another embodiment, the substituted, cross-linked starch consists essentially of a first substituted, cross-linked starch having a moderate process tolerance and a second substituted, cross-linked starch that is less process tolerant than the first substituted, cross-linked starch.

In an embodiment, the high amylose maize starch consists essentially of a single high amylose maize starch.

In another embodiment, the high amylose maize starch is an acetylated, high amylose maize starch.

In an embodiment, the high amylose maize starch consists essentially of a combination of two high amylose maize starches, optionally wherein the high amylose maize starch consists essentially of a first high amylose maize starch that is a native high amylose maize starch and a second high amylose maize starch that is an acetylated, high amylose maize starch. In another embodiment, the native high amylose maize starch has an amylose content of about 70 wt %.

In an embodiment, the acetylated, high amylose maize starch has an amylose content of about 68 wt %.

In an embodiment, the aqueous composition further comprises xanthan gum present in an amount of from about 0.025 wt % to about 1 wt % on a dry weight basis. In another embodiment, the aqueous composition further comprises a flour selected from rice flour and an ancient grain flour, optionally wherein the flour is rice flour, present in an amount of from about 10 wt % to about 30 wt % on a dry weight basis. In a further embodiment, the aqueous composition further comprises fiber, present in an amount of from about 0.1% to about 10% on a dry weight basis, optionally wherein the fiber is pea fiber, potato fiber or a combination thereof.

In an embodiment, the aqueous composition comprises:
water present in an amount of from about 55 wt % to about 70 wt % or about 64 wt %;
rice flour present in an amount of from about 15 wt % to about 25 wt % or about 20 wt % on a dry weight basis;
salt present in an amount of about 7.4 wt % on a dry weight basis;
turmeric extract present in an amount of less than about 1 wt % on a dry weight basis;
paprika extract present in an amount of less than about 1 wt % on a dry weight basis;
xanthan gum present in an amount of less than about 1 wt % on a dry weight basis;
optionally fiber present in an amount of from about 0.25 wt % to about 7 wt % on a dry weight basis, wherein the fiber is pea fiber, potato fiber or a combination thereof, optionally pea fiber;
optionally silicon dioxide present in an amount of less than about 0.1 wt % on a dry weight basis;
a hydroxypropylated, cross-linked tapioca starch present in an amount of from about 50 wt % to about 60 wt % on a dry weight basis; and
an acetylated, high amylose maize starch present in an amount of from about 20 wt % to about 30 wt % on a dry weight basis,
   wherein the ratio by weight of the hydroxypropylated, cross-linked tapioca starch to the acetylated, high amylose maize starch on a dry weight basis is about 70:30.

In another embodiment of the present disclosure, the aqueous composition has an actual solids ratio of about 20 wt % to about 70 wt %, optionally about 30 wt % to about 45 wt %, optionally about 36 wt %, based on the total weight of the aqueous composition.

The present disclosure also includes a process for preparing fried, coated vegetable articles, the process comprising:
coating vegetable articles with an aqueous starch-containing batter consisting of an aqueous composition for coating vegetable articles for frying of the present disclosure to obtain batter-coated vegetable articles; and
frying the batter-coated vegetable articles to obtain the fried, coated vegetable articles.

In an embodiment, the process comprises:
optionally processing vegetables into a desired shape and/or size to obtain vegetable articles;
blanching the vegetable articles to obtain blanched vegetable articles;
optionally contacting the blanched vegetable articles with a solution that reduces surface discoloration;
partially drying the blanched vegetable articles to obtain blanched, partially dried vegetable articles;
coating the blanched, partially dried vegetable articles with the aqueous starch-containing batter to obtain batter-coated vegetable articles;
optionally setting the batter-coated vegetable articles;
frying the batter-coated vegetable articles to obtain the fried, coated vegetable articles; and
optionally freezing the fried, coated vegetable articles to obtain frozen, fried, coated vegetable articles.

In an embodiment, the vegetable articles are potato articles. In another embodiment, the fried, coated vegetable articles are fried, coated French fries and the potato articles are potato strips or sticks. In a further embodiment, the blanched, optionally dipped potato articles are partially dried under conditions to obtain a moisture reduction of from about 8 wt % to about 10 wt % in the blanched potato articles. In an embodiment, the blanched potato articles are contacted with the solution that reduces surface discoloration.

In an embodiment, the fried, coated vegetable articles are par-fried, coated vegetable articles. In another embodiment, the step of frying comprises par-frying the batter-coated vegetable articles in a two stage fryer to obtain the par-fried, coated vegetable articles.

In another embodiment of the present disclosure, the batter-coating provides a continuous film over an individual vegetable article that remains continuous through the frying step.

In an embodiment, the process further comprises reconstitution-frying the optionally frozen, fried, coated vegetable articles to obtain reconstitution-fried, coated vegetable articles.

The present disclosure also includes a fried, coated vegetable article prepared according to a process for preparing fried, coated vegetable articles of the present disclosure. In an embodiment, the fried, coated vegetable article is a fried, coated French fry. In another embodiment, the fried, coated vegetable article is a reconstitution-fried, coated ⅜ cut French fry having a fat content that is reduced by about 23 wt % to about 45 wt % or about 23 wt % to about 33 wt % in comparison to a reconstitution-fried, uncoated ⅜ cut French fry having a fat content of 11.55 g/100 g that has been prepared using the same process except for the coating step.

The present disclosure also includes a fried vegetable article comprising a coating prepared from an aqueous composition for coating vegetable articles for frying of the present disclosure. In another embodiment, the fried vegetable article is a fried French fry. In a further embodiment, the fried vegetable article is a reconstitution-fried, coated ⅜ cut French fry prepared using an aqueous composition for coating vegetable articles such as potato strips or sticks for frying that comprises pea fiber and having a fat content that is reduced by about 35 wt % to about 45 wt % or about 39 wt % to about 43 wt % in comparison to a reconstitution-fried, uncoated ⅜ cut French fry having a fat content of 11.55 g/100 g that has been prepared using the same process except for the coating step.

The present disclosure also includes an aqueous composition for coating a vegetable article for frying, the aqueous composition comprising:
a hydroxypropylated, cross-linked tapioca starch; and
an acetylated, high amylose maize starch,
   wherein the hydroxypropylated, cross-linked tapioca starch is a hydroxypropyl di-starch phosphate.

The present disclosure also includes an aqueous composition for coating a food product, the aqueous composition comprising:
a substituted, cross-linked starch present in an amount of from about 45 wt % to about 65 wt % on a dry weight basis; and
a high amylose maize starch present in an amount of from about 15 wt % to about 35 wt % on a dry weight basis,
wherein the ratio by weight of the substituted, cross-linked starch to the high amylose maize starch on a dry weight basis is from about 60:40 to about 80:20.

In an embodiment, the aqueous composition further comprises xanthan gum present in an amount of from about 0.025 wt % to about 1 wt % on a dry weight basis. In another embodiment, the aqueous composition further comprises a flour selected from rice flour and an ancient grain flour, present in an amount of from about 10 wt % to about 30 wt % on a dry weight basis.

In an embodiment, the substituted, cross-linked starch is selected from a tapioca starch, a waxy maize starch, a maize starch and a sago starch.

In an embodiment, the substituted, cross-linked starch is a hydroxypropylated, cross-linked starch or an acetylated, cross-linked starch. In another embodiment, the substituted, cross-linked starch is a hydroxypropylated, cross-linked tapioca starch. It is an embodiment that the hydroxypropylated, cross-linked tapioca starch is a hydroxypropyl di-starch phosphate.

In an embodiment, the high amylose maize starch is an acetylated, high amylose maize starch. In another embodiment of the present disclosure, the ratio by weight of the substituted, cross-linked starch to the high amylose maize starch on a dry weight basis is about 70:30.

The present disclosure also includes a process for preparing fried, coated food products, the process comprising:
coating food products with an aqueous starch-containing batter consisting of an aqueous composition of the present disclosure to obtain batter-coated food products; and
frying the batter-coated food products to obtain the fried, coated food products.

In an embodiment, the process is a process for preparing fried, coated vegetable articles, the process comprising:
coating blanched vegetable articles with an aqueous starch-containing batter consisting of an aqueous composition of the present disclosure to obtain batter-coated vegetable articles; and
frying the batter-coated vegetable articles to obtain the fried, coated vegetable articles.

In an embodiment, the vegetable articles are potato articles.

In another embodiment, the blanched potato articles are prepared by a process comprising:
blanching potato articles under conditions to obtain freshly blanched potato articles;
dipping the freshly blanched potato articles in a solution that inhibits discoloration of the blanched potato articles to obtain blanched, dipped potato articles; and
partially drying the blanched, dipped potato articles under conditions to obtain a moisture reduction of from about 8 wt % to about 10 wt % in the freshly blanched potato articles to obtain the blanched potato articles.

In an embodiment, the fried, coated potato article is a fried, coated French fry.

In an embodiment, the coating provides a continuous film over an individual blanched vegetable article that remains continuous through the frying step.

The present disclosure also includes a fried, coated food product prepared according to a process for preparing fried, coated food products of the present disclosure. In an embodiment, the fried, coated food product is a fried, coated French fry.

The present disclosure also includes a fried food product comprising a coating prepared from an aqueous composition for coating food products of the present disclosure. In an embodiment, the fried food product is a fried French fry.

The present disclosure also includes an aqueous composition for coating a food product, the aqueous composition comprising:
a hydroxypropylated, cross-linked tapioca starch; and
an acetylated, high amylose maize starch,
   wherein the hydroxypropylated, cross-linked tapioca starch is a hydroxypropyl di-starch phosphate.

### BRIEF DESCRIPTION OF THE DRAWINGS

The present disclosure will now be described in greater detail with reference to the drawings, in which:

FIG. 1 is a schematic diagram of a process according to an embodiment of the present disclosure.

FIG. 2 is a schematic diagram of a process according to another embodiment of the present disclosure.

FIG. 3 shows exemplary osmium-stained images of cross-sections of a fried, uncoated French fry control (A) and a fried, coated French fry (B). The coating of the fried, coated French fry shown in (B) comprises a hydroxypropylated, cross-linked tapioca starch (Purity™ 4) and an acetylated, high amylose maize starch (Crispfilm™) in a ratio by weight of the hydroxypropylated, cross-linked tapioca starch to the acetylated, high amylose maize starch of about 70:30. The oil appears white in the images as a result of the osmium staining.

FIG. 4 shows exemplary confocal microscopy images of cross-sections of a fried, uncoated French fry control (A) and a fried, coated French fry (B). The coating of the fried, coated French fry shown in (B) comprises a hydroxypropylated, cross-linked tapioca starch (Purity™ 4) and an acetylated, high amylose maize starch (Crispfilm™) in a ratio by weight of the hydroxypropylated, cross-linked tapioca starch to the acetylated, high amylose maize starch of about 70:30. Nile red dye used for the confocal microscopy images highlights the oil as yellow in color images. The oil appears as light grey in the greyscale images of FIG. 4. The scale bar correlates to a length of 1.0 mm.

FIG. 5 shows exemplary stereomicrograph images of fried coatings comprising a hydroxypropylated, cross-linked tapioca starch (Purity™ 4) and an acetylated, high amylose maize starch (Crispfilm™) in a ratio by weight of the hydroxypropylated, cross-linked tapioca starch to the acetylated, high amylose maize starch of about 70:30 (A) and about 30:70 (B).

FIG. 6 shows exemplary hot stage microscopy images of a mixture comprising a hydroxypropylated, cross-linked tapioca starch (Purity™ 4) and an acetylated, high amylose maize starch (Crispfilm™) in a ratio by weight of the hydroxypropylated, cross-linked tapioca starch to the acetylated, high amylose maize starch of about 70:30.

FIG. 7 shows plots showing the (A) moisture (g/100 g) and (B) fat (g/100 g) as a function of the reconstitution cook time for fried, coated French fries prepared with a batter comprising a starch blend having a 70:30 ratio of Purity 4:Crispfilm (×) vs. a batter comprising a starch blend having a 35:35:30 ratio by weight of Purity 4:Purity 87:Crispfilm (+).

### DETAILED DESCRIPTION

### I. Definitions

Unless otherwise indicated, the definitions and embodiments described in this and other sections are intended to be applicable to all embodiments and aspects of the disclosure herein described for which they are suitable as would be understood by a person skilled in the art.

As used in this disclosure, the singular forms “a”, “an” and “the” include plural references unless the content clearly dictates otherwise.

In embodiments comprising an “additional” or “second” component, the second component as used herein is different from the other components or first component. A “third” component is different from the other, first, and second components, and further enumerated or “additional” components are similarly different.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The term “dry weight basis” as used herein, includes the moisture content naturally present in a starch.

The term “actual solids ratio” as used herein refers to a solids ratio obtained using instrumentation for measuring solids such as a Sartorious, which measures the actual solids % in a slurry.

Certain terms which are used herein refer to items which may be known under more than one name in the English language. A person skilled in the art would readily understand that the term “maize starch” as used herein refers to a starch which may also be known as “corn starch”.

The term “native starch” as used herein refers to a starch extracted from a starch-bearing crop in its natural form, i.e. the starch has not been chemically, enzymatically and/or physically modified, and includes a starch extracted from a starch-bearing crop that has been bred and/or genetically engineered to have a different amylose content in its starch.

The term “modified starch” as used herein refers to a starch that has been prepared by treating a native starch, for example chemically, enzymatically and/or physically treating a native starch. In an embodiment, the modified starch is prepared by chemically treating a native starch and may also be referred to herein as being a “chemically modified starch”, as being “chemically modified” or as having “chemical modifications” and the like. In an embodiment, the chemically modified starch is substituted and/or cross-linked. In another embodiment, the chemically modified starch is substituted and cross-linked. In a further embodiment of the present disclosure, the chemically modified starch is substituted.

The term “substituted” and the like as used herein in reference to a starch means that the starch has been chemically modified via the addition of at least one type of chemical blocking group to the starch polymer backbone. Substitution may, for example lower the gelatinization temperature of a starch and/or stabilize a starch, which may, for example inhibit retrogradation. The effect that this has on process stability is useful to its function. It will be appreciated that retrogradation is a process occurring after starch gelatinization, when the paste is subject to cooling. During cooling, the linear portions of amylose and amylopectin chains realign themselves, as the starch is crystallizing. Retrogradation of the long chain amylose occurs at a rate which is more rapid than amylopectin retrogradation. Amylopectin retrogradation happens at a rate which is dependent, for example on the temperature, moisture content and chain lengths of the amylopectin side branches. It will be appreciated that water repulsion, commonly known as “syneresis” can occur during retrogradation. Substitution is useful for amylose-containing starches to prevent the re-association of amylose molecules, as the blocking agents inhibit this, giving, for example, a more freeze/thaw stable product.

In an embodiment, the chemical blocking group is a hydroxyalkyl group such as a hydroxypropyl group. If the chemical blocking group (i.e. the substitution) is a hydroxypropyl group, the starch is optionally referred to herein as being “hydroxypropylated”. In another embodiment, the chemical blocking group (i.e. the substitution) is an acetyl group, in which case the starch is optionally referred to herein as being “acetylated”. Acetylated starches are generally less freeze thaw stable than hydroxypropylated starches. Substituted starches may be commercially available and/or they may be prepared by a suitable synthetic route. Regulatory agencies such as the United States Food and Drug Administration (FDA) may set limits on the amount of substitution in starches used for food applications. The selection of a starch having a substitution level meeting the regulatory standards for a food application can be made by a person skilled in the art.

The term “cross-linked” and the like as used herein in reference to a starch means that the starch has been chemically modified via the introduction of covalent bonds within the starch so that inter- and/or intramolecular bridges (i.e. cross-links) are formed between starch polymer backbones. Cross-linking may, for example control granular swelling and/or inhibit viscosity breakdown through processing. As the number of cross-links is increased, the starch generally becomes more tolerant to conditions such as heat, acid and shears. Cross-linked starches may be commercially available and/or they may be prepared by a suitable synthetic route. For example, a cross-linked starch can be obtained from a process comprising the reaction of a starch with a suitable cross-linking agent under conditions to form the cross-linked starch. Regulatory agencies such as the United States Food and Drug Administration (FDA) may set limits on the amount of cross-links in starches used for food applications. The selection of a starch having a cross-linking level meeting the regulatory standards for a food application can be made by a person skilled in the art.

The term “cross-linking agent” as used herein refers to a reagent that reacts with a starch to form cross-links within the starch under conditions to form a cross-linked starch. In an embodiment, the cross-linking agent is phosphorous oxychloride (POCl₃).

The expressions “tolerance to processing” or “process tolerance” and the like as used herein in reference to a starch refers, for example, to how tolerant the starch is to break down, shear, pH and temperature. It would be appreciated by a person skilled in the art that starches can be classified, for example as having low, moderate or high process tolerance as well as values in-between such as but not limited to low-moderate process tolerance. The starches herein are optionally described as having more or less process tolerance with respect to a comparator starch. For example, Purity™ 87 (a starch having a “high” process tolerance) is optionally described herein as being more process tolerant than Purity™ 4 (a starch having a “moderate” process tolerance) and National Frigex™ HV (a starch having a “low-moderate” process tolerance) is optionally described herein as being less process tolerant than Purity™ 4.

Optionally, the Breakdown:Peak (B:P) ratio as described herein can be used to indicate the process tolerance of a starch. It will be appreciated by a person skilled in the art that when comparing the B:P ratio of starches, experimental conditions (i.e. temperature, shear rate, sample concentration) and modifications (i.e. substitution) are kept consistent across samples. Optionally, for tapioca-based hydroxypropyl di-starch phosphates, Purity™ 87 (a starch having a “high” process tolerance) has a B:P ratio of from about 0.18-0.22; Purity™ 4 (a starch having a “moderate” process tolerance) has a B:P ratio of from about 0.34-0.43; and National Frigex™ HV (a starch having a “low-moderate” process tolerance) has a B:P ratio of from about 0.38-0.42. One of skill in the art can readily identify, for example, other tapioca-based hydroxypropyl di-starch phosphates which are high process tolerance starches, moderate process tolerance starches and low-moderate process starches falling in these ranges.

The term “pea fiber” as used herein refers to fiber extracted from a pea; i.e. derived from any suitable variety of the species Pisum sativum. Pea fiber may be prepared by a suitable route and/or may be commercially available. For example, the pea fiber can be Pea Fibre I50M.

The term “potato fiber” as used herein refers to fiber extracted from a potato. Potato fiber may be prepared by a suitable route and/or may be commercially available. For example, the potato fiber can be Roquette potato fibre.

### II. Compositions and Kits

In the present disclosure, aqueous compositions for coating food products such as potato articles, for example French fries have been developed. Food products such as fried, coated potato articles, for example fried, coated French fries have been prepared using such aqueous compositions. Compositions comprising various ratios of a substituted, cross-linked starch such as a hydroxypropylated, cross-linked tapioca starch and a high amylose maize starch such as an acetylated, high amylose maize starch were used in the studies of the present disclosure. Reconstitution-fried, ⅜ cut French fries coated with a composition comprising a substituted, cross-linked starch and a high amylose maize starch were observed in the present studies to have higher values for fat reduction in comparison to conventional batters. Reconstitution-fried, ⅜ cut French fries coated with a composition comprising a ratio by weight of a tapioca starch with a hydroxypropyl di-starch phosphate modification to an acetylated, high amylose maize starch of 70:30 on a dry weight basis were observed to have values for average fat that were reproducible; i.e. had a low standard deviation between trials. Consistency of result is very advantageous for a commercial food product. Food service restaurants often attempt to achieve consistent product quality and attributes. Low fat food products should also be reliably produced so that low-fat claims made to the public and any regulatory authorities can be substantiated upon testing of the food product, even though different batches of the composition were used.

Accordingly, the present disclosure includes an aqueous composition for coating a food product, the aqueous composition comprising:
a substituted, cross-linked starch; and
a high amylose maize starch.

The substituted, cross-linked starch is optionally a combination of two or more substituted, cross-linked starches, for example a combination of two substituted, cross-linked starches. The high amylose maize starch is optionally a combination of two or more high amylose maize starches, for example a combination of two high amylose maize starches.

The selection of a suitable substituted, cross-linked starch or a combination thereof can be made by a person skilled in the art. In an embodiment, the substituted, cross-linked starch is an acetylated, cross-linked starch or a hydroxyalkylated, cross-linked starch such as a hydroxypropylated, cross-linked starch. In another embodiment, the substituted, cross-linked starch is a hydroxypropylated, cross-linked starch or an acetylated, cross-linked starch. In a further embodiment, the substituted, cross-linked starch is a hydroxypropylated, cross-linked starch. It is an embodiment that the substituted, cross-linked starch is an acetylated, cross-linked starch.

In an embodiment, the hydroxypropylated, cross-linked starch has cross-links comprising phosphate esters.

In an embodiment, the substituted, cross-linked starch is a hydroxypropyl di-starch phosphate. In another embodiment, the substituted, cross-linked starch is a hydroxypropyl di-starch phosphate having a tapioca base such as Purity™ 4. Other hydroxypropyl di-starch phosphates having a tapioca base are also known such as Purity™ 87 or National Frigex™ HV.

In an embodiment, the substituted, cross-linked starch is an acetylated di-starch phosphate. In another embodiment, the substituted, cross-linked starch is an acetylated di-starch phosphate having a maize base such as Purity™ NCSA or a waxy maize base such as Purity™ SCSA.

In an embodiment, the substituted, cross-linked starch such as a hydroxypropylated, cross-linked tapioca starch, for example a hydroxypropyl di-starch phosphate having a tapioca base has a viscosity of about 300 to about 400 BU at a solids ratio of about 13.5%.

In an embodiment of the present disclosure, the substituted, cross-linked starch such as a hydroxypropylated, cross-linked starch has been prepared from a native starch in a one stage process.

In another embodiment, the substituted, cross-linked starch such as a hydroxypropylated, cross-linked starch has been prepared from a native starch in a two stage process, the first stage comprising a substitution of the native starch, for example with propylene oxide under conditions to give a hydroxypropylated starch and the second stage comprising a cross-linking of the substituted, for example hydroxypropylated starch with a cross-linking agent under conditions to give the substituted, cross-linked starch such as a hydroxypropylated, cross-linked starch. In a further embodiment, the cross-linking agent is phosphorous oxychloride.

While not wishing to be limited by theory, it is believed that the first substitution stage of such a two-stage process opens up the starch granule so that a cross-linking agent used in the second stage may gain greater access into the starch granule and may penetrate deeper within the matrix. Starches prepared by such a two stage process may, for example be more stable at frying temperatures and/or may have useful moisture management properties such as binding water which may allow better function of the starches upon frying than substituted, cross-linked starches such as hydroxypropylated, cross-linked starches prepared by a one-stage process.

In an embodiment, the substituted, cross-linked starch is selected from the group consisting of a tapioca starch, a sago starch, a waxy maize starch and a maize starch.

In another embodiment, the substituted cross-linked starch is a hydroxypropylated, cross-linked starch selected from the group consisting of a tapioca starch, a sago starch, a waxy maize starch and a maize starch. It is an embodiment that the hydroxypropylated, cross-linked starch is a tapioca starch.

In an embodiment, the substituted, cross-linked starch is an acetylated, cross-linked starch selected from the group consisting of a tapioca starch, a sago starch, a waxy maize starch and a maize starch. It is an embodiment that the acetylated starch is a waxy maize starch or a maize starch.

It will be appreciated that the amylose content of the substituted, cross-linked starch will depend, for example on the source of the starch. In an embodiment, the substituted, cross-linked starch is a hydroxypropylated, cross-linked tapioca starch having an amylose content of from about 15 wt % to about 19 wt %. In another embodiment, the hydroxypropylated, cross-linked tapioca starch has an amylose content of about 17 wt %. In another embodiment, the substituted, cross-linked starch is an acetylated, cross-linked waxy maize starch having an amylose content of less than about 1 wt %. In a further embodiment, the substituted, cross-linked starch is an acetylated, cross-linked maize starch having an amylose content of about 20 wt % to about 30 wt %. It is an embodiment that the acetylated, cross-linked maize starch has an amylose content of about 25 wt %.

In an embodiment, the substituted, cross-linked starch comprises, consists essentially of or consists of a single substituted, cross-linked starch. Accordingly, in an embodiment of the present disclosure, the aqueous composition for coating a food product comprises:
a substituted, cross-linked starch present in an amount of from about 45 wt % to about 65 wt % on a dry weight basis; and
a high amylose maize starch present in an amount of from about 15 wt % to about 35 wt % on a dry weight basis,
   wherein the ratio by weight of the substituted, cross-linked starch to the high amylose maize starch on a dry weight basis is from about 60:40 to about 80:20, and optionally wherein the substituted, cross-linked starch comprises, consists essentially of or consists of a single substituted, cross-linked starch and the high amylose maize starch comprises, consists essentially of or consists of a single high amylose maize starch.

In an embodiment, the substituted, cross-linked starch such as a hydroxypropylated, cross-linked starch is present in an amount of from about 50 wt % to about 60 wt % on a dry weight basis. In another embodiment, the high amylose maize starch such as an acetylated, high amylose maize starch is present in an amount of from about 20 wt % to about 30 wt % on a dry weight basis.

In the studies of the present disclosure, fried, coated French fries having lower fat contents than a fried, uncoated French fry control were prepared in a process which included coating potato strips with batters comprising a blend of Purity 4 (a tapioca-based hydroxypropyl di-starch phosphate with a moderate process tolerance) and either Purity 87 (a tapioca-based hydroxypropyl di-starch phosphate with a high process tolerance) or National Fridgex HV (a tapioca-based hydroxypropyl di-starch phosphate with a low-moderate process tolerance) in addition to the acetylated, high amylose maize starch Crispfilm. Accordingly, in another embodiment of the present disclosure, the substituted, cross-linked starch comprises, consists essentially of or consists of a combination of two substituted, cross-linked starches, wherein each of the substituted, cross-linked starches has a different process tolerance.

In an embodiment, the substituted, cross-linked starch comprises, consists essentially of or consists of a first substituted, cross-linked starch having a moderate process tolerance and a second substituted, cross-linked starch that is more process tolerant than the first substituted, cross-linked starch, for example it is a high process tolerance starch. In another embodiment, the first substituted, cross-linked starch with a moderate process tolerance is a tapioca-based hydroxypropyl di-starch phosphate with a moderate process tolerance such as Purity 4. In another embodiment, the first substituted, cross-linked starch with a moderate process tolerance is a tapioca-based hydroxypropyl di-starch phosphate with a B:P ratio of from about 0.34-0.43. In a further embodiment, the second substituted, cross-linked starch with a high process tolerance is a tapioca-based hydroxypropyl di-starch phosphate with a high process tolerance such as Purity 87. In another embodiment, the second substituted, cross-linked starch with a high process tolerance is a tapioca-based hydroxypropyl di-starch phosphate with a B:P ratio of from about 0.18-0.22. In another embodiment, the ratio by weight of the starch with the moderate process tolerance to the starch with the high process tolerance is from about 30:70 to about 70:30 or about 50:50, based on the total weight of the substituted, cross-linked starch on a dry weight basis.

In an embodiment, the substituted, cross-linked starch comprises, consists essentially of or consists of a first substituted, cross-linked starch having a moderate process tolerance and a second substituted, cross-linked starch that is less process tolerant than the first substituted, cross-linked starch, for example it is a low or low-moderate process tolerance starch. In an embodiment, the first substituted, cross-linked starch with a moderate process tolerance is a tapioca-based hydroxypropyl di-starch phosphate with a moderate process tolerance such as Purity 4. In another embodiment, the first substituted, cross-linked starch with a moderate process tolerance is a tapioca-based hydroxypropyl di-starch phosphate with a B:P ratio of from about 0.34-0.43. In another embodiment, the second substituted, cross-linked starch with a low or low-moderate process tolerance is a tapioca-based hydroxypropyl di-starch phosphate with a low-moderate process tolerance such as National Frigex HV. In another embodiment, the second substituted, cross-linked starch with a low or low-moderate process tolerance is a tapioca-based hydroxypropyl di-starch phosphate with a B:P ratio of from about 0.38-0.42. It will be appreciated that other tapioca-based substituted, cross-linked starches having a low process tolerance are known such as National™ 78-0148 (a hydroxypropyl di-starch phosphate). In another embodiment, the ratio by weight of the starch with the moderate process tolerance to the starch with the low-moderate process tolerance is from about 25:75 to about 75:25 or about 70:30, based on the total weight of the substituted, cross-linked starch on a dry weight basis.

The selection of a suitable high amylose maize starch or a combination thereof can be made by a person skilled in the art. In an embodiment, the high amylose maize starch is a native high amylose maize starch. In another embodiment, the native high amylose maize starch has an amylose content of about 50 wt % to about 80 wt %. In an embodiment, the native high amylose maize starch has an amylose content of at least about: 50 wt %, 70 wt % or 80 wt %, optionally about: 50 wt %, 70 wt % or 80 wt %. In a further embodiment, the native high amylose maize starch has an amylose content of at least about 70 wt %, optionally about 70 wt %.

In another embodiment, the high amylose maize starch is a modified high amylose maize starch. In an embodiment, the high amylose maize starch is a substituted, high amylose maize starch. In another embodiment, the substituted, high amylose maize starch is an acetylated, high amylose maize starch (i.e. a starch acetate) such as Crispfilm™. It will be appreciated by a person skilled in the art that the amylose content of the substituted, high amylose maize starch such as an acetylated, high amylose maize starch will depend, for example on the particular native high amylose maize starch used in the preparation of the substituted, high amylose maize starch such as an acetylated, high amylose maize starch. High amylose maize starches are those having an amylose content of at least about 50 wt %.

In an embodiment, the acetylated, high amylose maize starch has an amylose content of from about 50 wt % to about 80 wt %. In another embodiment, the acetylated, high amylose maize starch has an amylose content of from about 50 wt % to about 70 wt %. In a further embodiment, the acetylated, high amylose maize starch has an amylose content of at least about: 50 wt % or 70 wt %, optionally about: 50 wt % or 70 wt %. In a further embodiment of the present disclosure, the acetylated, high amylose maize starch has an amylose content of about 68 wt %, optionally at least about 68 wt %.

It will be appreciated by a person skilled in the art that the high amylose content of the high amylose maize starch is useful, for example to create a strong linear film in, for example a par-fry stage of the processes of the present disclosure and/or to inhibit re-absorption of oil when a food product coated with a coating prepared from the aqueous compositions of the present disclosure exits an operator's fryer. It will also be appreciated that there are other sources of useful high amylose starches.

In an embodiment, the high amylose maize starch comprises, consists essentially of or consists of a single high amylose maize starch.

In the studies of the present disclosure, fried, coated French fries having lower fat contents than a fried uncoated French fry control were prepared in a process which comprised coating potato strips with batters comprising a blend of Crispfilm (an acetylated, high amylose maize starch having 68 wt % amylose) and Hylon VII (a native high amylose maize starch having 70 wt % amylose) in addition to a single tapioca starch or a tapioca starch blend.

Accordingly, in another embodiment, the high amylose maize starch comprises, consists essentially of or consists of a combination of two high amylose maize starches. In an embodiment, the high amylose maize starch comprises, consists essentially of or consists of a first high amylose maize starch that is a native high amylose maize starch, optionally a native high amylose maize starch having about 70 wt % amylose such as Hylon VII and a second high amylose maize starch that is an acetylated, high amylose maize starch, optionally an acetylated, high amylose maize starch having about 68 wt % amylose such as Crispfilm. In another embodiment, the ratio by weight of the native high amylose maize starch to the acetylated, high amylose maize starch is from about 1:10 to about 10:1, optionally about 2:1, based on the total weight of the high amylose maize starch blend on a dry weight basis.

In another embodiment, the substituted, cross-linked starch comprises, consists essentially of or consists of a combination of two substituted, cross-linked starches, wherein each of the substituted, cross-linked starches has a different process tolerance and the high amylose maize starch comprises, consists essentially of or consists of a combination of two high amylose maize starches. In an embodiment, the substituted, cross-linked starch comprises, consists essentially of or consists of a first substituted, cross-linked starch having a moderate process tolerance and a second substituted, cross-linked starch that is more process tolerant than the first substituted, cross-linked starch, for example it is a high process tolerance starch. In another embodiment, the first substituted, cross-linked starch with a moderate process tolerance is a tapioca-based hydroxypropyl di-starch phosphate with a moderate process tolerance such as Purity 4. In another embodiment, the first substituted, cross-linked starch with a moderate process tolerance is a tapioca-based hydroxypropyl di-starch phosphate with a B:P ratio of from about 0.34-0.43. In a further embodiment, the second substituted, cross-linked starch with a high process tolerance is a tapioca-based hydroxypropyl di-starch phosphate with a high process tolerance such as Purity 87. In another embodiment, the second substituted, cross-linked starch with a high process tolerance is a tapioca-based hydroxypropyl di-starch phosphate with a B:P ratio of from about 0.18-0.22. In another embodiment, the ratio by weight of the starch with the moderate process tolerance to the starch with the high process tolerance is from about 30:70 to about 70:30 or about 50:50, based on the total weight of the substituted, cross-linked starch on a dry weight basis. In another embodiment, the high amylose maize starch comprises, consists essentially of or consists of a first high amylose maize starch that is a native high amylose maize starch, optionally a native high amylose maize starch having about 70 wt % amylose such as Hylon VII and a second high amylose maize starch that is an acetylated, high amylose maize starch, optionally an acetylated, high amylose maize starch having about 68 wt % amylose such as Crispfilm. In another embodiment, the ratio by weight of the native high amylose maize starch to the acetylated, high amylose maize starch is from about 1:10 to about 10:1, optionally about 2:1, based on the total weight of the high amylose maize starch blend on a dry weight basis.

In another embodiment, the ratio by weight of the substituted, cross-linked starch to the high amylose maize starch on a dry weight basis is from about 60:40 to about 80:20. In another embodiment, the ratio by weight of the substituted, cross-linked starch to the high amylose maize starch on a dry weight basis is about 70:30.

In an embodiment, the amylose content of the aqueous composition is from about 20 wt % to about 40 wt %, about 27 wt % to about 32 wt %, about 25 wt % to about 29 wt %, about 30 wt % to about 34 wt %, about 27 wt % or about 32 wt %. In another embodiment of the present disclosure, the amylose content of the aqueous composition is about 27 wt %. In a further embodiment, the amylose content of the aqueous composition is about 33 wt %.

In an embodiment, the aqueous composition has an actual solids ratio of about 20 wt % to about 70 wt %, about 30 wt % to about 45 wt % or about 36 wt % based on the total weight of the aqueous composition.

While not wishing to be limited by theory, the addition of suitable amounts of a flour such as rice flour may, for example be useful in film formation as it may at least partially fill in holes in the film. Rice flour may also be useful for color blending and/or final crispness in a fried food product coated with a coating comprising rice flour. Flours made from ancient grains such as quinoa and spelt may also be useful in the aqueous compositions of the present disclosure. Accordingly, in an embodiment, the aqueous composition optionally further comprises one or more flours selected from a rice flour and an ancient grain flour such as quinoa flour or spelt flour. In an embodiment, the aqueous composition further comprises rice flour in an amount of from about 10 wt % to about 30 wt %, about 15 wt % to about 25 wt % or about 20 wt % on a dry weight basis.

In an embodiment, the aqueous composition optionally further comprises a salt suitable for use in food applications. It will be appreciated that regulatory agencies may set limits on the amount and/or types of salt used in foods. The selection of a suitable salt and amount thereof to meet the regulatory standards for a food application can be made by a person skilled in the art. It will also be appreciated that salt may contribute, for example to flavor, to starch order, and may hold onto some available moisture in a coating, thereby lowering a starch gelatinization temperature. Accordingly, in an embodiment, the salt comprises, consists essentially of or consists of one or more of sodium chloride (NaCl), potassium chloride (KCl) and calcium chloride (CaCl₂). In another embodiment, the salt comprises, consists essentially of or consists of sodium chloride. In a further embodiment, the aqueous composition comprises a salt such as sodium chloride in an amount of about 5 wt % to about 10 wt % on a dry weight basis. In another embodiment, the aqueous composition comprises a salt such as sodium chloride in an amount of about 7.4 wt % on a dry weight basis.

In an embodiment of the present disclosure, the aqueous composition optionally further comprises a stabilizer, for example an agent that assists in keeping starches in suspension in their cold state. It will be appreciated that such an agent is useful for example, for processing. The selection of a suitable stabilizer, for example, the agent that assists in keeping starches in suspension in their cold state for a particular aqueous composition will depend, for example, on factors such as cost and/or the desired viscosity of the aqueous composition and can be made by a person skilled in the art. In an embodiment, the stabilizer, for example the agent that assists in keeping starches in suspension in their cold state comprises, consists essentially of or consists of xanthan gum. In an embodiment, the aqueous composition comprises xanthan gum in an amount of from about 0 wt % to about 5 wt % or about 0 wt % to about 1 wt % on a dry weight basis. In another embodiment, the aqueous composition comprises xanthan gum in an amount of less than about 5 wt % or less than about 1 wt % on a dry weight basis. In another embodiment, the xanthan gum is present in an amount of about 0.025 wt % to about 1 wt % on a dry weight basis. In a further embodiment, the aqueous composition comprises xanthan gum in an amount of from about 0.05 wt % to about 0.5 wt % on a dry weight basis.

In an embodiment, the aqueous composition optionally further comprises at least one coloring agent. Coloring agents are known in the art and the selection of a suitable coloring agent for a particular aqueous composition of the present disclosure can be made by a person skilled in the art. For example, for at least some uses, it would be useful to select a coloring agent which may give a substantially smooth, even color through a fried, coated food product that has an absence of visual pieces as would be observed for coatings comprising ground colors such as those comprising brown spices. Accordingly, in an embodiment, the at least one coloring agent comprises, consists essentially of or consists of at least one oil soluble extract having at least one coloring compound therein. In another embodiment, the at least one coloring agent comprises, consists essentially of or consists of at least one of paprika extract (also known as paprika oleoresin) and turmeric extract. In another embodiment, the at least one coloring agent comprises, consists essentially of or consists of paprika extract and turmeric extract. It will be appreciated that an extract such as turmeric extract or paprika extract may also be used as a flavoring agent as well as a coloring agent. However, it will be appreciated that at low levels, such an extract is added to the aqueous composition as a coloring agent. In an embodiment, the aqueous composition comprises turmeric extract in an amount of from about 0 wt % to about 5 wt % or about 0 wt % to about 1 wt % on a dry weight basis. In another embodiment, the aqueous composition comprises turmeric extract in an amount of less than about 5 wt % or less than about 1 wt % on a dry weight basis. In another embodiment, the aqueous composition comprises turmeric extract in an amount of from about 0.05 wt % to about 5 wt % or about 0.1 wt % to about 1 wt % on a dry weight basis. In another embodiment, the aqueous composition comprises paprika extract in an amount of from about 0 wt % to about 5 wt % or about 0 wt % to about 1 wt % on a dry weight basis. In another embodiment, the aqueous composition comprises paprika extract in an amount of less than about 5 wt % or less than about 1 wt % on a dry weight basis. In another embodiment, the aqueous composition comprises paprika extract in an amount of from about 0.05 wt % to about 5 wt % or about 0.1 wt % to about 1 wt % on a dry weight basis. Coloring agents such as paprika extract and turmeric extract are available from commercial sources.

In an embodiment, the aqueous composition optionally further comprises an anti-caking agent such as silicon dioxide in a fine powder form. The selection of a suitable silicon dioxide for a particular aqueous composition of the present disclosure and/or use thereof can be made by a person skilled in the art. It will be appreciated that an anti-caking agent may be useful as a processing aid, for example in a plant environment. It will also be appreciated that whether or not silicon dioxide would be useful as a processing aid will depend, for example on the particular plant. In an embodiment, the aqueous composition comprises silicon dioxide in an amount of less than about 1 wt % or less than about 0.1 wt % on a dry weight basis. In another embodiment, the aqueous composition comprises from about 0.01 wt % to about 0.1 wt % silicon dioxide.

In the studies of the present disclosure, batter formulations comprising a starch blend with either a 70:30 ratio by weight of Purity 4:Crispfilm or a starch blend with a 35:35:30 ratio by weight of Purity 4:Purity 87:Crispfilm in combination with varying amounts of potato fiber and/or pea fiber were used to prepare fried coated French fries having reduced fat in comparison to a fried, uncoated French fry control. Accordingly, in an embodiment, the aqueous composition further comprises fiber such as pea fiber, potato fiber or a combination thereof. In an embodiment, the fiber is pea fiber. In another embodiment, the fiber is potato fiber. Other fibers such as oat fiber may also optionally be used in the aqueous compositions of the present disclosure. The selection of a suitable fiber can be made by a person skilled in the art. In an embodiment, the aqueous composition comprises from about 0.1 wt % to about 10 wt %, optionally about 0.25 wt % to about 7 wt % fiber on a dry weight basis.

In an embodiment, the aqueous composition comprises, consists essentially of or consists of:
water present in an amount of from about 30 wt % to about 80 wt %;
rice flour present in an amount of from about 10 wt % to about 30 wt % on a dry weight basis;
salt present in an amount of about 5 wt % to about 10 wt % on a dry weight basis;
turmeric extract present in an amount of less than about 5 wt % on a dry weight basis;
paprika extract present in an amount of less than about 5 wt % on a dry weight basis;
xanthan gum present in an amount of less than about 5 wt % on a dry weight basis;
optionally fiber present in an amount of from about 0.1 wt % to about 10 wt % on a dry weight basis, wherein the fiber is pea fiber, potato fiber or a combination thereof, optionally pea fiber;
optionally silicon dioxide present in an amount of less than about 1 wt % on a dry weight basis;
a hydroxypropylated, cross-linked tapioca starch present in an amount of from about 45 wt % to about 65 wt % on a dry weight basis; and
an acetylated, high amylose maize starch present in an amount of from about 15 wt % to about 35 wt % on a dry weight basis,
   wherein the ratio by weight of the hydroxypropylated, cross-linked tapioca starch to the acetylated, high amylose maize starch on a dry weight basis is from about 60:40 to about 80:20.

In another embodiment, the aqueous composition comprises, consists essentially of or consists of:
water present in an amount of from about 55 wt % to about 70 wt % or about 64 wt %;
rice flour present in an amount of from about 15 wt % to about 25 wt % or about 20 wt % on a dry weight basis;
salt present in an amount of about 7.4 wt % on a dry weight basis;
turmeric extract present in an amount of less than about 1 wt % on a dry weight basis;
paprika extract present in an amount of less than about 1 wt % on a dry weight basis;
xanthan gum present in an amount of less than about 1 wt % on a dry weight basis;
optionally fiber present in an amount of from about 0.25 wt % to about 7 wt % on a dry weight basis, wherein the fiber is pea fiber, potato fiber or a combination thereof, optionally pea fiber;
optionally silicon dioxide present in an amount of less than about 0.1 wt % on a dry weight basis;
a hydroxypropylated, cross-linked tapioca starch present in an amount of from about 50 wt % to about 60 wt % on a dry weight basis; and
an acetylated, high amylose maize starch present in an amount of from about 20 wt % to about 30 wt % on a dry weight basis,
   wherein the ratio by weight of the hydroxypropylated, cross-linked tapioca starch to the acetylated, high amylose maize starch on a dry weight basis is about 70:30.

In an embodiment, the substituted, cross-linked starch and the high amylose maize starch together comprise about 70 wt % of dry ingredients in the aqueous composition.

The present disclosure also includes a composition for use in an aqueous starch-containing batter for coating a food product, the composition comprising:
a substituted, cross-linked starch; and
a high amylose maize starch.

It will be appreciated by a person skilled in the art that the composition for use in an aqueous starch-containing batter for coating a food product of the present disclosure may be varied as discussed above in relation to a corresponding embodiment for an aqueous composition for coating a food product of the present disclosure except for those embodiments which relate specifically to an aqueous composition, for example solids ratios. A person skilled in the art would readily understand which embodiments relate specifically to an aqueous composition. A person skilled in the art would also be able to, for example convert values given on a dry weight basis in embodiments relating to the aqueous compositions for coating a food product of the present disclosure to wt % of a composition for use in an aqueous starch-containing batter for coating a food product of the present disclosure.

Accordingly, in an embodiment, the composition for use in an aqueous starch-containing batter for coating a food product comprises:
a substituted, cross-linked starch present in an amount of from about 45 wt % to about 65 wt %; and
a high amylose maize starch present in an amount of from about 15 wt % to about 35 wt %,
   wherein the ratio by weight of the substituted, cross-linked starch to the high amylose maize starch is from about 60:40 to about 80:20, and optionally wherein the substituted, cross-linked starch comprises, consists essentially of or consists of a single substituted, cross-linked starch and the high amylose maize starch comprises, consists essentially of or consists of a single high amylose maize starch.

A person skilled in the art would readily understand how to prepare an aqueous starch-containing batter for coating a food product using a composition for use in an aqueous starch-containing batter for coating a food product of the present disclosure. For example, the dry ingredients of the composition for use in an aqueous starch-containing batter for coating a food product of the present disclosure are mixed with water according to proportions described in the present disclosure.

The present disclosure also includes a kit for making batter, the kit comprising the substituted, cross-linked starch and the high amylose maize starch as dry ingredients for a kit user to mix according to proportions described in the present disclosure, and optionally with written instructions for making a batter.

In an embodiment of the present disclosure, the food product is a fried, coated food product. In another embodiment, the food product is a fried, coated vegetable article; i.e. the aqueous composition is an aqueous composition for coating a fried, coated vegetable article. It will be appreciated by a person skilled in the art that in such embodiments, the coating of the fried, coated vegetable article is derived from the aqueous composition. In another embodiment, the fried, coated vegetable article optionally further comprises additional food components such as non-vegetable components. In a further embodiment, the food product is a fried, coated root vegetable article. In another embodiment, the food product is a fried, coated tuberous root vegetable article. It is an embodiment that the food product is a fried, coated potato article. In an embodiment, the fried, coated potato article is prepared from a potato article comprising at least a portion of any processing variety of potato or any processing variety of sweet potato. In another embodiment, the potato article is selected from a whole potato, a potato half, a potato quarter, a potato wedge, a potato strip or stick, a potato cube, a potato slice and a novelty cut of potato such as but not limited to a spiral shape. In another embodiment, the potato article is selected from a potato wedge and a potato strip or stick. In a further embodiment, the potato article is a potato strip or stick. It is an embodiment that the food product is a fried, coated French fry or a fried, coated sweet potato fry. In another embodiment, the food product is a fried, coated French fry. In an embodiment, the food product is a fried, coated sweet potato fry. The selection of a suitable cut of potato for a fried, coated French fry or a fried, coated sweet potato fry can be made by a person skilled in the art. In an embodiment, the food product is a fried, coated shoestring French fry or a fried, coated square cut French fry. Example cut sizes are 9/32 to 19/64 inch shoestring cut French fries or 3/16 inch to 1.5 inch square cut French fries. Optionally, the French fries are sliced as ⅜ inch cut French fries. In an embodiment, the potato article is a 9/32 to 19/64 inch cut for shoestring cut French fries or a 3/16 inch to 1.5 inch cut for square cut French fries. Optionally, the potato articles are sliced for ⅜ inch cut French fries.

In an embodiment of the present disclosure, the aqueous composition for coating a food product is an aqueous composition for coating a food product for frying. In another embodiment, the aqueous composition for coating a food product is an aqueous composition for coating a vegetable article for frying. In another embodiment, the vegetable article for frying optionally further comprises additional food components such as non-vegetable components. In a further embodiment, the aqueous composition for coating a food product is an aqueous composition for coating a root vegetable article for frying. In another embodiment, the aqueous composition for coating a food product is an aqueous composition for coating a tuberous root vegetable article for frying. It is an embodiment that the aqueous composition for coating a food product is an aqueous composition for coating a potato article for frying. In an embodiment, the potato article comprises at least a portion of any processing variety of potato or any processing variety of sweet potato. In another embodiment, the potato article is selected from a whole potato, a potato half, a potato quarter, a potato wedge, a potato strip or stick, a potato cube, a potato slice and a novelty cut of potato such as but not limited to a spiral shape. In another embodiment, the potato article is selected from a potato wedge and a potato strip or stick. In a further embodiment, the potato article is a potato strip or stick. In another embodiment, the aqueous composition for coating a food product is an aqueous composition for coating a potato or sweet potato stick or strip for frying to obtain a fried, coated French fry or a fried, coated sweet potato fry. In another embodiment, the aqueous composition for coating a food product is an aqueous composition for coating a potato stick or strip for frying to obtain a fried, coated French fry. In an embodiment, the aqueous composition for coating a food product is an aqueous composition for coating a sweet potato stick or strip for frying to obtain a fried, coated sweet potato fry. The selection of a suitable cut of potato for a fried, coated French fry or a fried, coated sweet potato fry can be made by a person skilled in the art. In an embodiment, the fried, coated French fry is a fried, coated shoestring French fry or a fried, coated square cut French fry. Example cut sizes are 9/32 to 19/64 inch shoestring cut French fries or 3/16 inch to 1.5 inch square cut French fries. Optionally, the French fries are sliced as ⅜ inch cut French fries. In an embodiment, the potato article is a 9/32 to 19/64 inch cut for shoestring cut French fries or a 3/16 inch to 1.5 inch cut for square cut French fries. Optionally, the potato articles are sliced for ⅜ inch cut French fries.

### III. Processes

In the present disclosure, processes for preparing fried, coated food products such as fried, coated potato articles, for example fried, coated French fries have been developed. Food products such as fried, coated potato articles, for example fried, coated French fries have been prepared using such processes. Such processes have been observed in the present disclosure to produce a fried, coated French fry having a batter-coating that is a continuous film. Such processes have also been observed in the present disclosure to produce a reconstitution-fried, coated French fry having a reduced percentage of fat in comparison to a reconstitution-fried, uncoated French fry prepared by the same process except without a batter-coating step. Such processes have also been observed in the present disclosure to produce a reconstitution-fried, coated French fry having a higher value of fat reduction in comparison to conventional batters. Processes comprising coating blanched ⅜ cut potato strips with an aqueous starch-containing batter comprising a tapioca starch with a hydroxypropyl di-starch phosphate modification and an acetylated, high amylose maize starch in a ratio by weight of about 70:30 on a dry weight basis prepared French fries having values for average fat that were reproducible; i.e. had a low standard deviation between trials.

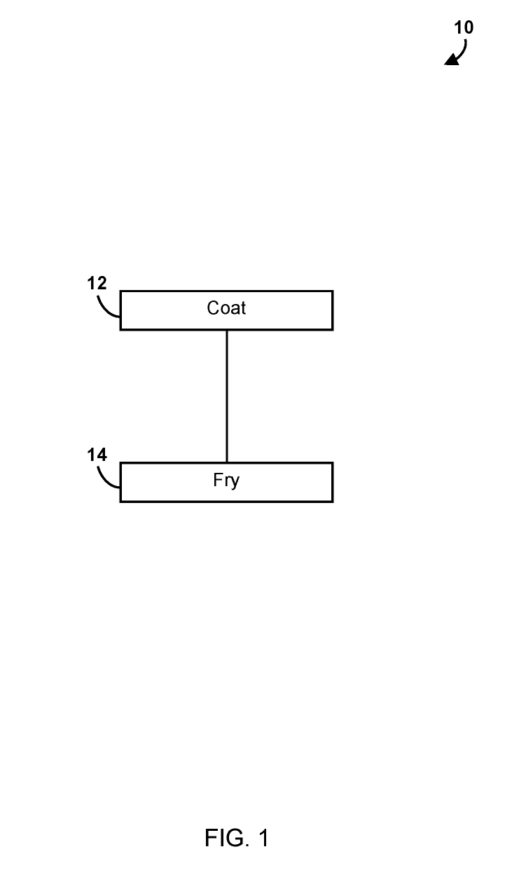

An exemplary process flow diagram is shown in FIG. 1. The exemplified process 10 is a process for preparing fried, coated food products such as fried, coated potato articles. Referring to FIG. 1, in the exemplified process 10, food products such as blanched potato articles (not shown) are coated in a coating step 12 with an aqueous starch-containing batter of the present disclosure to obtain batter-coated food products such as batter-coated potato articles (not shown). The batter-coated food products such as batter-coated potato articles (not shown) are then fried in a frying step 14 to obtain the fried, coated food products such as fried, coated potato articles (not shown).

Accordingly, the present disclosure also includes a process for preparing fried, coated food products, the process comprising:
coating food products with an aqueous starch-containing batter comprising, consisting essentially of or consisting of an aqueous composition for coating food products of the present disclosure to obtain batter-coated food products; and
frying the batter-coated food products to obtain the fried, coated food products.

It will be appreciated by a person skilled in the art that embodiments relating to the aqueous compositions for coating food products of the present disclosure used in the processes for preparing fried, coated food products of the present disclosure can be varied as discussed herein for the aqueous compositions for coating food products of the present disclosure.

Accordingly, in an embodiment of the present disclosure, the process for preparing fried, coated food products comprises:
coating food products with an aqueous starch-containing batter to obtain batter-coated food products, the aqueous starch-containing batter comprising:
   a substituted, cross-linked starch present in an amount of from about 45 wt % to about 65 wt % on a dry weight basis; and
   a high amylose maize starch present in an amount of from about 15 wt % to about 35 wt % on a dry weight basis,
wherein the ratio by weight of the substituted, cross-linked starch to the high amylose maize starch on a dry weight basis is from about 60:40 to about 80:20, optionally wherein the substituted, cross-linked starch comprises, consists essentially of or consists of a single substituted, cross-linked starch and the high amylose maize starch comprises, consists essentially of or consists of a single high amylose maize starch; and
frying the batter-coated food products to obtain the fried, coated food products.

In an embodiment of the present disclosure, the fried, coated food product is a fried, coated vegetable article. In another embodiment, the vegetable article optionally further comprises additional food components such as non-vegetable components. In another embodiment, the fried, coated food product is a fried, coated root vegetable article. In a further embodiment, the fried, coated food product is a fried, coated tuberous root vegetable article. It is an embodiment that the fried, coated food product is a fried, coated potato article.

Accordingly, in another embodiment of the present disclosure, the process for preparing fried, coated food products is a process for preparing fried, coated vegetable articles, the process comprising:
coating vegetable articles, optionally wherein the vegetable articles are blanched vegetable articles, with an aqueous starch-containing batter comprising, consisting essentially of or consisting of an aqueous composition for coating vegetable articles for frying of the present disclosure to obtain batter-coated vegetable articles; and
frying the batter-coated vegetable articles to obtain the fried, coated vegetable articles.

In an embodiment of the present disclosure, the process for preparing fried, coated vegetable articles comprises:
coating vegetable articles, optionally wherein the vegetable articles are blanched vegetable articles, with an aqueous starch-containing batter to obtain batter-coated vegetable articles, the aqueous starch-containing batter comprising:
   a substituted, cross-linked starch present in an amount of from about 45 wt % to about 65 wt % on a dry weight basis; and
   a high amylose maize starch present in an amount of from about 15 wt % to about 35 wt % on a dry weight basis,
wherein the ratio by weight of the substituted, cross-linked starch to the high amylose maize starch on a dry weight basis is from about 60:40 to about 80:20, optionally wherein the substituted, cross-linked starch comprises, consists essentially of or consists of a single substituted, cross-linked starch and the high amylose maize starch comprises, consists essentially of or consists of a single high amylose maize starch; and
frying the batter-coated vegetable articles to obtain the fried, coated vegetable articles.

In another embodiment, the blanched vegetable articles such as blanched potato articles are prepared by a process comprising:
blanching vegetable articles such as potato articles under conditions to obtain freshly blanched vegetable articles such as freshly blanched potato articles;
dipping the freshly blanched vegetable articles such as freshly blanched potato articles in a solution that inhibits discoloration of the blanched vegetable articles such as blanched potato articles to obtain blanched, dipped vegetable articles such as blanched, dipped potato articles; and
partially drying the blanched, dipped vegetable articles such as blanched, dipped potato articles under conditions to obtain a moisture reduction of from about 8 wt % to about 10 wt % in the freshly blanched vegetable articles such as freshly blanched potato articles to obtain the blanched vegetable articles such as blanched potato articles.

In another embodiment of the present disclosure, the process for preparing fried, coated food products is a process for preparing fried, coated potato articles, comprising:
coating blanched potato articles with an aqueous starch-containing batter comprising, consisting essentially of or consisting of an aqueous composition for coating potato articles for frying of the present disclosure to obtain batter-coated potato articles; and
frying the batter-coated potato articles to obtain the fried, coated potato articles.

In an embodiment of the present disclosure, the process for preparing fried, coated potato articles comprises:
coating blanched potato articles with an aqueous starch-containing batter to obtain batter-coated potato articles, the aqueous starch-containing batter comprising:
   a substituted, cross-linked starch present in an amount of from about 45 wt % to about 65 wt % on a dry weight basis; and
   a high amylose maize starch present in an amount of from about 15 wt % to about 35 wt % on a dry weight basis,
wherein the ratio by weight of the substituted, cross-linked starch to the high amylose maize starch on a dry weight basis is from about 60:40 to about 80:20, optionally wherein the substituted, cross-linked starch comprises, consists essentially of or consists of a single substituted, cross-linked starch and the high amylose maize starch comprises, consists essentially of or consists of a single high amylose maize starch; and
frying the batter-coated potato articles to obtain the fried, coated potato articles.

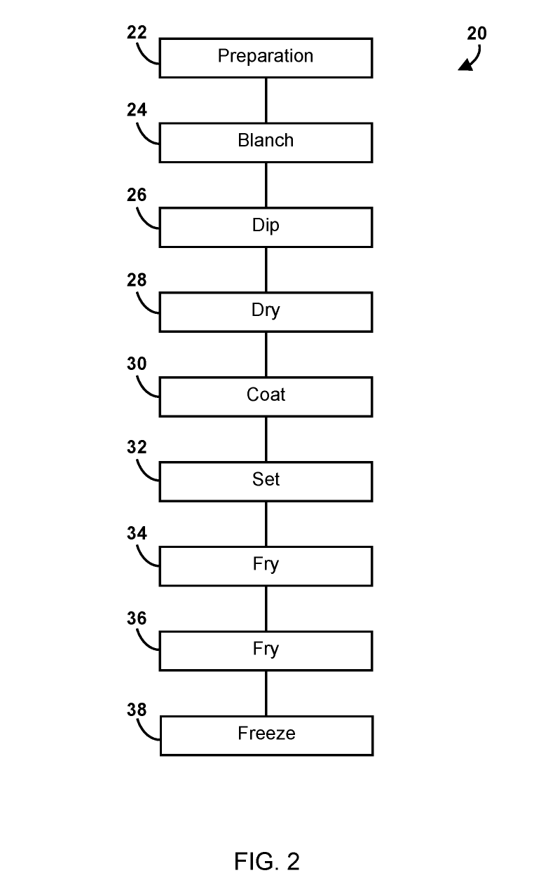

FIG. 2 shows an embodiment of a process for preparing fried, coated vegetable articles such as fried, coated potato articles of the present disclosure. The process is optionally described herein with respect to potatoes for illustrative purposes. The most common par-fried vegetable products are made from potatoes. Referring to FIG. 2, in the exemplified process 20, potatoes (not shown) are prepared in a preparation step 22 to obtain potato articles (not shown). The potato articles (not shown) are then blanched in a blanching step 24 to obtain blanched potato articles (not shown). The blanched potato articles (not shown) optionally undergo a dipping step 26 and/or a drying step 28 prior to being coated with an aqueous starch-containing batter of the present disclosure in coating step 30 to obtain batter-coated potato articles (not shown). The batter-coated potato articles (not shown) then optionally undergo a setting step 32 prior to being fried in one or optionally two frying steps (34, 36) to obtain fried, coated potato articles (not shown). The fried, coated potato articles are then optionally frozen in a freezing step 38.

The operations carried out in the preparation step 22 will depend on the fried, coated vegetable articles such as the fried, coated potato articles to be prepared in the process. For example, when the fried, coated vegetable articles are fried, coated potato articles, preparation step 22 can include but is not limited to operations such as grading the potatoes to select potatoes of a desired shape and/or size, washing the potatoes, for example to remove soil, peeling the potatoes to remove at least a portion of the peel on the potatoes, pre-heating the potatoes, for example using a hot water bath and cutting and/or processing the potatoes to a desired shape and/or size. The selection of suitable operations to be carried out in the preparation step 22 for a particular fried, coated vegetable article such as a fried, coated potato article can be made by a person skilled in the art. For example, if potato skin is to be retained on the fried, coated potato article, the preparation step 22 includes washing the potatoes.

The potatoes used in the processes for preparing fried, coated potato articles of the present disclosure can be of any processing variety including, but not limited to, Maris Piper, Pentland Dell, Markies, Shepody, Premiere, Russet Burbank, Bintje, Innovator and Morene. The potatoes used in the processes can also be of any processing variety of sweet potatoes. It will be readily apparent that parameters may be adapted depending on the type of potato variety used, since different varieties can, for example have different contents of sugars and other solids, and depending on whether a potato or a sweet potato is used in the processes. It will also be readily apparent that one can adapt the potato methods and apparatus to other root vegetables or tubers such as but not limited to yams, carrots and beets.

For example, the fried, coated vegetable articles can be fried, coated root vegetable or tuber articles such as but not limited to fried, coated yam articles, fried, coated parsnip articles, fried, coated carrot articles, fried, coated beet articles, fried, coated cassava articles, fried, coated sweet potato articles or fried, coated potato articles. Accordingly, in an embodiment, the fried, coated vegetable articles are prepared from root vegetable or tuber articles comprising at least a portion of any suitable processing variety of a yam, parsnip, carrot, beet, cassava, sweet potato or potato.

In an embodiment, the vegetable articles are potato articles and in preparation step 22, potatoes are cut into a desired shape and/or size to obtain the potato articles. For example, if the process for preparing fried, coated vegetable articles is a process for preparing fried, coated French fries or fried, coated sweet potato fries, the potatoes can be cut into shapes that are commonly referred to in the art as sticks or strips, for example longitudinal sticks or strips. The selection of a suitable cut of potato for a fried, coated French fry or a fried, coated sweet potato fry can be made by a person skilled in the art. Alternatively, the potatoes are cut into, for example but not limited to halves, quarters, wedges, cubes, slices or a novelty cut such as but not limited to a spiral shape. Alternatively, the potatoes are not cut after washing and optionally peeling, and the potato articles comprise the whole, washed and optionally peeled potatoes. Accordingly, in an embodiment, the potato article is selected from a whole potato, a potato half, a potato quarter, a potato wedge, a potato strip or stick, a potato cube, a potato slice and a novelty cut of potato such as but not limited to a spiral shape. In another embodiment, the potato article is selected from a potato wedge and a potato strip or stick. In a further embodiment, the potato article is a potato strip or stick. In an embodiment, the potato article is a 9/32 to 19/64 inch cut for shoestring cut French fries or a 3/16 inch to 1.5 inch cut for square cut French fries. Optionally, the potato articles are sliced for ⅜ inch cut French fries. It will be appreciated by a person skilled in the art that the shape and/or size of the vegetable article such as the potato article can have an influence on the fat content of the fried, coated vegetable article such as the fried, coated potato article.

In optional blanching step 24, enzymes can be inactivated and/or sugars removed from the surface of vegetable articles such as potato articles which, if not removed, may cause discoloration of certain vegetable articles such as potato articles. In the blanching step 24, vegetable articles such as potato articles are blanched for a time and at a temperature under conditions to obtain the blanched vegetable articles such as blanched potato articles. The conditions to obtain the blanched vegetable articles such as blanched potato articles may vary, for example based on the size and/or the shape of the vegetable articles such as potato articles. The selection of suitable conditions to obtain the desired blanched vegetable articles such as blanched potato articles can be made by a person skilled in the art.

In an embodiment, the vegetable articles such as potato articles are blanched by immersing the vegetable articles such as potato articles in heated water, for example in a hot water bath or by deluging the vegetable articles such as potato articles under hot water sprays for a time and at a temperature to obtain the blanched vegetable articles such as potato articles, for example for a time of about 8 to about 20 minutes at a temperature of from about 70° C. to about 90° C. Alternatively, the vegetable articles such as potato articles are blanched by exposing the potato articles to heated steam for a time and at a temperature to obtain the blanched vegetable articles such as blanched potato articles, for example for a time of about 5 minutes to about 10 minutes at a temperature of about 100° C. It will be appreciated by a person skilled in the art that other alternative methods of blanching can be used such as but not limited to pulsed electric field (PEF). It will also be appreciated by a person skilled in the art that shorter blanching times may reduce cell damage and/or rupture. Accordingly, in an embodiment of the present disclosure, the potato articles are blanched for a minimal blanching time. In an embodiment, the minimal blanching time is a time of less than about 10 minutes.

It will be appreciated by a person skilled in the art that certain blanched vegetable articles such as blanched potato articles can undergo a discoloration that is commonly referred to as after-cooking darkening (ACD) due to a reaction comprising the oxidation of an iron-containing complex. While this discoloration has not been observed to significantly influence the coating of a fried, coated potato article, it will be appreciated that a consumer may, for example find a fried, coated potato article comprising a discolored potato to be cosmetically unappealing. Accordingly, in the optional dipping step 26, the blanched potato articles are contacted, for example immersed in a solution that inhibits discoloration of the potato articles due to iron oxidation. The selection of a suitable solution that inhibits discoloration of the potato articles due to iron oxidation can be made by a person skilled in the art. In an embodiment, the solution that inhibits discoloration of the potato articles due to iron oxidation comprises sodium acid pyrophosphate (SAPP). In another embodiment, the solution that inhibits discoloration of the potato articles due to iron oxidation comprises sodium acid pyrophosphate (SAPP) in an amount of about 0.6 wt % to about 1 wt %.

In the optional drying step 28, the vegetable articles such as potato articles are partially dried under conditions to obtain a desired moisture reduction in the blanched vegetable articles such as blanched potato articles. Partially drying the vegetable articles such as potato articles equilibrates the moisture content therein, controlling the moisture loss in the fryer and/or in the case of starchy vegetable articles such as potato articles creates a thin, partially gelatinized layer of starch on the surface. It will be appreciated by a person skilled in the art that this surface layer will, for example allow better adhesion of a batter to the starchy vegetable article such as the potato article and/or inhibit a further depth of oil penetration when frying. The conditions to obtain a desired moisture reduction in the vegetable articles such as potato articles may vary, for example based on the size and/or the shape of the vegetable articles such as potato articles, and the incoming solids. The selection of suitable conditions can be made by a person skilled in the art. The conditions are generally plant-specific and are controlled with relative humidity (RI-1%). In an embodiment, the drying step 28 comprises placing the vegetable articles such as potato articles in an elevated temperature environment such as a drying oven at a temperature and for a time to obtain the desired moisture reduction, for example for a time of about 5 minutes to about 15 minutes at a temperature of about 30° C. to about 70° C. Alternatively, the drying step 28 comprises drying the vegetable articles such as potato articles at ambient temperature for a time to obtain the desired moisture reduction. It will be appreciated by a person skilled in the art that dry losses for different vegetable articles such as potato articles may vary and the selection of a suitable dry loss for a particular vegetable article can be made by a person skilled in the art. It is an embodiment of the present disclosure that the moisture reduction is about 6 wt % to about 10 wt % based on the total weight of the potato articles. In another embodiment, the moisture reduction is about 8 wt % to about 10 wt % or about 8 wt % to about 9 wt %.

In coating step 30, the vegetable articles such as potato articles are coated with an aqueous starch-containing batter of the present disclosure to obtain batter-coated vegetable articles such as batter-coated potato articles. In an embodiment, the aqueous starch-containing batter is an aqueous composition for coating a food product of the present disclosure. Conditions for coating vegetable articles such as potato articles are known in the art, for example those that comprise using conventional coating equipment. In an embodiment, the conditions comprise using, for example but not limited to a waterfall enrober, a submerger enrober, spraying or dipping. The selection of suitable conditions for coating vegetable articles such as potato articles can be made by a person skilled in the art. In an embodiment of the present disclosure, the process comprises coating the vegetable articles such as potato articles with a submerger enrober such as a submerger enrober with an overflow curtain. Optionally, the batter-coated vegetable articles such as batter-coated potato articles are passed before a blower subsequent to the coating step 30. The blower can remove, for example at least a portion of excess batter.

In the optional setting step 32, the batter-coated vegetable articles such as batter-coated potato articles are set under conditions to obtain a desired adherence of the batter coating to the vegetable articles such as the potato articles. Conditions to obtain the desired adherence of the batter coating to the vegetable articles such as the potato articles may vary, for example based on the shape, size and/or surface area of the vegetable articles such as the potato articles. The selection of suitable conditions to obtain the desired adherence of the batter coating for particular vegetable articles such as potato articles can be made by a person skilled in the art. In an embodiment, the conditions comprise setting the batter-coated vegetable articles such as batter-coated potato articles for a time and at a temperature to obtain the desired adherence. A time of at least about 20 seconds is useful to allow sufficient adherence of the batter coating to the vegetable articles such as potato articles. In an embodiment, the temperature is an ambient temperature, for example from about 18° C. to about 25° C. In an embodiment, the conditions to obtain the desired adherence comprise conveying the batter-coated vegetable articles such as batter-coated potato articles from a batter-coating location to a frying location in the process of the present disclosure at an ambient temperature, for example from about 18° C. to about 25° C. In another embodiment, the conditions to obtain the desired adherence comprise setting the batter-coated vegetable articles such as batter-coated potato articles for a time and at a temperature to obtain a desired moisture reduction. The desired moisture reduction will depend, for example, on the shape, size and/or surface area of the vegetable articles such as potato articles. In an embodiment, the moisture reduction is from about 3 wt % to about 10 wt % based on the total weight of the batter-coated potato articles.

The fat content of a fried, coated vegetable article such as a fried, coated potato article, for example a fried, coated French fry may also depend, for example on the batter pick-up. It will be appreciated that a useful batter pick-up for a particular fried, coated vegetable article such as a fried, coated potato article may depend, for example on the cut size of the vegetable article such as the potato article, for example a potato strip or stick. In an embodiment of the present disclosure, the potato article is an about ⅜ cut potato strip or stick that is coated with an aqueous starch-containing batter of the present disclosure under conditions to obtain a batter-coated ⅜ cut potato strip or stick having a batter pick-up of about 11 wt % to about 13 wt % (measured after setting step 32, if the process comprises a setting step) based on the total weight of the batter-coated ⅜ cut potato strip or stick. In another embodiment, the batter-coated potato article is a batter-coated ⅜ cut potato strip or stick having a batter pick-up of about 12 wt % (measured after setting step 32, if the process comprises a setting step) based on the total weight of the batter-coated ⅜ cut potato strip or stick.

In the one or optionally two frying steps (34, 36), the batter-coated vegetable articles such as batter-coated potato articles are fried in fat such as oil under conditions to obtain the fried, coated vegetable articles such as fried, coated potato articles. The conditions to obtain the fried, coated vegetable articles such as fried, coated potato articles may vary, for example based on the size and/or shape of the vegetable articles such as potato articles. The selection of suitable conditions to obtain the desired fried, coated vegetable articles such as fried, coated potato articles can be made by a person skilled in the art. In an embodiment, the step of frying comprises one step. In another embodiment of the processes of the present disclosure, the step of frying comprises two steps. For example, the batter-coated vegetable articles such as batter-coated potato articles can be fried in a two stage fryer under conditions to obtain the fried, coated vegetable articles such as fried, coated potato articles. In an embodiment of the processes of the present disclosure, the step of frying comprises par-frying the batter-coated vegetable articles such as batter-coated potato articles to obtain par-fried, coated vegetable articles such as par-fried, coated potato articles. In another embodiment, the step of frying comprises par-frying the batter-coated vegetable articles such as batter-coated potato articles in a two stage fryer under conditions to obtain the par-fried, coated vegetable articles such as par-fried, coated potato articles.

In an embodiment, the conditions to obtain the par-fried, coated vegetable articles such as the par-fried, coated potato articles comprise frying the batter-coated vegetable articles such as batter-coated potato articles in a first stage at a temperature and for a time so that the batter coating sets to a sufficient extent, for example at a temperature of at least about 160° C., for example about 160° C. to about 175° C. or about 172° C. for a time of at least about 8 seconds, for example about 8 seconds to about 20 seconds or about 13 seconds, then frying in a second stage at a temperature and for a time that is sufficient to cook the batter and remove further moisture so as to obtain the par-fried, coated vegetable articles such as par-fried, coated potato articles, for example at a temperature of at least about 170° C., for example about 170° C. to about 185° C. or about 176° C. for a time of at least about 15 seconds, for example about 12 seconds to about 24 seconds or about 17 seconds.

In an embodiment, the total time for par-frying is from about 19 seconds to about 44 seconds or about 30 seconds. In an embodiment, the potato articles are ⅜ cut potato strips, the time of the first stage is about 13 seconds at a temperature of about 172° C., and the time of the second stage is about 17 seconds at a temperature of about 176° C. Such a time and temperature can minimize moisture removal and/or reduce cook-out and damage of the starch. It will be appreciated by a person skilled in the art that conventional frying processes expel moisture from the batter then draw moisture from inside the product into the batter as the moisture originally in the batter is expelled. A hydroxypropylated, cross-linked starch such as a tapioca starch in the aqueous starch-containing batters of the present disclosure binds the moisture in the first stage of the fryer and continues to function in the second stage. A substituted, high amylose maize starch then sets down in this matrix and has a minimal function in the par-fry stage.

In another embodiment, the frying step(s) (34, 36) comprise finish-frying the batter-coated vegetable articles such as batter-coated potato articles to obtain finish-fried vegetable articles such as finish-fried potato articles. The finish-fried vegetable articles such as finish-fried potato articles can optionally be consumed but are suitably frozen in freezing step 38 and optionally reconstituted by any suitable means known in the art.

Fats such as oils used to fry batter-coated vegetable articles such as batter-coated potato articles are known in the art and include but are not limited to sunflower oil, rapeseed oil, non-hydrogenated canola oil and vegetable oil blends. In an embodiment, the oil comprises, consists essentially of or consists of sunflower oil, rapeseed oil, non-hydrogenated canola oil or a vegetable oil blend. In another embodiment, the oil comprises, consists essentially of or consists of sunflower oil or non-hydrogenated canola oil.

Subsequent to the one or optionally two frying steps (34, 36) the fried, coated vegetable articles such as fried, coated potato articles are removed from the fryer and optionally excess surface oil is removed, for example using an air blower. In an embodiment, the optional step of removing excess surface oil from the fried, coated vegetable articles such as the fried, coated potato articles comprises blowing air on the fried, coated vegetable articles such as fried, coated potato articles for a time of about 2-3 seconds at ambient temperature.

In an embodiment of the present disclosure, the process optionally comprises a freezing step 38. For example, the fried, coated vegetable articles such as fried, coated potato articles are optionally chilled and then subsequently frozen under conditions to obtain frozen, fried, coated vegetable articles such as frozen, fried, coated potato articles. Such conditions are known in the art and the selection of suitable conditions to obtain the frozen, fried, coated vegetable articles such as frozen, fried, coated potato articles can be made by a person skilled in the art. In an embodiment, the frozen, fried, coated vegetable articles such as frozen, fried, coated potato articles have a temperature of a maximum of about −10° C. It will be appreciated that the frozen, fried, coated vegetable articles such as frozen, fried, coated potato articles can be packaged using techniques that are well known in the art.

Methods for reconstituting (optionally frozen) fried, coated vegetable articles such as (optionally frozen) fried, coated potato articles are known in the art. In an embodiment, the processes of the present disclosure optionally comprise a reconstitution frying step. For example, the frozen, fried, coated vegetable articles such as frozen, fried, coated potato articles are fried under conditions to obtain reconstitution-fried, coated potato articles such as reconstitution-fried, coated French fries. Such conditions may vary, for example based on the size and/or the shape of the vegetable articles such as potato articles and whether the step(s) of frying (34, 36) prepared par-fried or finish-fried coated vegetable articles such as potato articles. The selection of suitable conditions to obtain the reconstitution-fried, coated vegetable articles such as reconstitution-fried, coated potato articles can be made by a person skilled in the art. In an embodiment, the reconstitution-fried, coated vegetable articles such as reconstitution-fried, coated potato articles are reconstitution-fried, coated ⅜ cut French fries and the conditions to obtain the reconstitution-fried, coated potato articles comprise frying frozen, par-fried, ⅜ cut French fries in a suitable oil for a time of about 3 minutes at a temperature of about 175° C. It will be appreciated by a person skilled in the art that when reconstituting vegetable articles such as potato articles by frying at a particular temperature a longer time is typically used for vegetable articles such as potato articles having, for e.g. a thicker cut size.

In an embodiment, the fried, coated vegetable articles such as fried, coated potato articles, for example fried, coated French Fries have a batter-coating that is a continuous film. In another embodiment, the batter-coating provides a continuous layer over an individual vegetable article such as an individual potato article that remains continuous through the frying step(s).

Accordingly, in an embodiment, the process for preparing fried, coated food products is a process for preparing fried, coated vegetable articles such as fried, coated potato articles, the process comprising:
optionally processing vegetables such as a potatoes into a desired shape and/or size to obtain vegetable articles such as potato articles;
optionally blanching the vegetable articles such as potato articles to obtain blanched vegetable articles such as blanched potato articles;
optionally contacting the blanched vegetable articles such as blanched potato articles with a solution that reduces surface discoloration;
optionally partially drying the blanched vegetable articles such as blanched potato articles to obtain blanched, partially dried vegetable articles such as blanched, partially dried potato articles;
coating the blanched, partially dried vegetable articles such as blanched, partially dried potato articles with an aqueous starch-containing batter comprising, consisting essentially of or consisting of an aqueous composition for coating vegetable articles such as potato articles for frying of the present disclosure to obtain batter-coated vegetable articles such as batter-coated potato articles;
optionally setting the batter-coated vegetable articles such as batter-coated potato articles;
frying the batter-coated vegetable articles such as batter-coated potato articles to obtain the fried, coated vegetable articles such as fried, coated potato articles; and
optionally freezing the fried, coated vegetable articles such as fried, coated potato articles to obtain frozen, fried, coated vegetable articles such as frozen, fried coated potato articles.

In another embodiment, the process for preparing fried, coated vegetable articles comprises:
optionally processing vegetables into a desired shape and/or size to obtain vegetable articles;
blanching the vegetable articles to obtain blanched vegetable articles;
optionally contacting the blanched vegetable articles with a solution that reduces surface discoloration;
partially drying the blanched vegetable articles to obtain blanched, partially dried vegetable articles;
coating the blanched, partially dried vegetable articles with an aqueous starch-containing batter to obtain batter-coated vegetable articles, the aqueous starch-containing batter comprising:
   a substituted, cross-linked starch present in an amount of from about 45 wt % to about 65 wt % on a dry weight basis; and
   a high amylose maize starch present in an amount of from about 15 wt % to about 35 wt % on a dry weight basis,
wherein the ratio by weight of the substituted, cross-linked starch to the high amylose maize starch on a dry weight basis is from about 60:40 to about 80:20, and optionally wherein the substituted, cross-linked starch comprises, consists essentially of or consists of a single substituted, cross-linked starch and the high amylose maize starch comprises, consists essentially of or consists of a single high amylose maize starch;
optionally setting the batter-coated vegetable articles;
frying the batter-coated vegetable articles to obtain the fried, coated vegetable articles; and
optionally freezing the fried, coated vegetable articles to obtain frozen, fried, coated vegetable articles.

In another embodiment, the process for preparing fried, coated vegetable articles is a process for preparing frozen, fried, coated vegetable articles, comprising:
processing vegetables into a desired shape and/or size to obtain vegetable articles;
blanching the vegetable articles to obtain blanched vegetable articles;
contacting the blanched vegetable articles with a solution that reduces surface discoloration to obtain blanched, dipped vegetable articles;
partially drying the blanched, dipped vegetable articles to obtain blanched, dipped, partially dried vegetable articles;
coating the blanched, dipped, partially dried vegetable articles with an aqueous starch-containing batter to obtain batter-coated vegetable articles, the aqueous starch-containing batter comprising:
   a substituted, cross-linked starch present in an amount of from about 45 wt % to about 65 wt % on a dry weight basis; and
   a high amylose maize starch present in an amount of from about 15 wt % to about 35 wt % on a dry weight basis,
wherein the ratio by weight of the substituted, cross-linked starch to the high amylose maize starch on a dry weight basis is from about 60:40 to about 80:20, and optionally wherein the substituted, cross-linked starch comprises, consists essentially of or consists of a single substituted, cross-linked starch and the high amylose maize starch comprises, consists essentially of or consists of a single high amylose maize starch;
setting the batter-coated vegetable articles;
frying the batter-coated vegetable articles to obtain fried, coated vegetable articles; and
freezing the fried, coated vegetable articles to obtain the frozen, fried, coated vegetable articles.

### IV. Fried Food Products

In the present disclosure, aqueous compositions for coating food products such as potato articles, for example French fries and processes for preparing fried, coated food products such as fried, coated potato articles, for example fried, coated French fries have been developed. Food products such as fried, coated potato articles, for example fried, coated French fries have been prepared using such aqueous compositions and processes. Such compositions and processes have been observed in the present disclosure to produce a fried, coated French fry having a batter-coating that is a continuous film. Such compositions and processes have also been observed in the present disclosure to produce a reconstitution-fried, coated French fry having a reduced percentage of fat in comparison to a reconstitution-fried, uncoated French fry prepared by the same process except without a batter-coating step. Such processes and compositions have also been observed in the present disclosure to produce a reconstitution-fried, coated French fry having a higher value of fat reduction in comparison to conventional batters. Processes comprising coating blanched ⅜ cut potato strips with a starch-containing batter consisting of an aqueous composition comprising a tapioca starch with a hydroxypropyl di-starch phosphate modification and an acetylated, high amylose maize starch in a ratio by weight of about 70:30 on a dry weight basis prepared French fries having values for average fat that were reproducible; i.e. had a low standard deviation between trials.

Accordingly, the present disclosure also includes a fried food product comprising a coating prepared from an aqueous composition for coating a food product of the present disclosure.

In an embodiment of the present disclosure, the fried food product is a fried vegetable article. In another embodiment, the vegetable article optionally further comprises additional food components such as non-vegetable components. In another embodiment, the fried food product is a fried root vegetable article. In a further embodiment, the fried food product is a fried tuberous root vegetable article. It is an embodiment that the fried food product is a fried potato article. In an embodiment, the fried potato article is prepared from a potato article comprising at least a portion of any processing variety of potato or any processing variety of sweet potato. In another embodiment, the potato article is selected from a whole potato, a potato half, a potato quarter, a potato wedge, a potato strip or stick, a potato cube, a potato slice and a novelty cut of potato such as but not limited to a spiral shape. In another embodiment, the potato article is selected from a potato wedge and a potato strip or stick. In a further embodiment, the potato article is a potato strip or stick. In an embodiment, the potato article is a 9/32 to 19/64 inch cut for shoestring cut French fries or a 3/16 inch to 1.5 inch cut for square cut French fries. Optionally, the potato articles are sliced for ⅜ inch cut French fries. It is an embodiment that the fried food product is a fried French fry or a fried sweet potato fry. In another embodiment, the fried food product is a fried French fry. In an embodiment, the fried food product is a fried sweet potato fry. The selection of a suitable cut of potato for a fried French fry or a fried sweet potato fry can be made by a person skilled in the art.

In another embodiment, the fried food product is a reconstitution-fried, coated ⅜ cut French fry having a fat content that is reduced by about 23 wt % to about 45 wt %, about 23 wt % to about 33 wt %, about 25 wt % to about 30 wt % or about 30 wt % in comparison to a reconstitution-fried, uncoated ⅜ cut French fry having a fat content of 11.55 g/100 g that has been prepared using the same process except for the coating step.

In an embodiment of the present disclosure, the batter-coating is a continuous film.

In another embodiment, the fried food product is a reconstitution-fried, coated ⅜ cut French fry prepared using an aqueous composition for coating vegetable articles such as potato strips or sticks for frying of the present disclosure comprising fiber, optionally pea fiber, and having a fat content that is reduced by about 35 wt % to about 45 wt % or about 39 wt % to about 43 wt % in comparison to a reconstitution-fried, uncoated ⅜ cut French fry having a fat content of 11.55 g/100 g that has been prepared using the same process except for the coating step.

In an embodiment, the fried food product is a par-fried food product. In another embodiment, the par-fried food product has been frozen. In a further embodiment, the fried food product is a finish-fried food product, optionally a frozen, finish-fried food product. In another embodiment of the present disclosure, the fried food product is a reconstitution-fried food product.

The present disclosure also includes a fried, coated food product prepared according to a process for preparing fried, coated food products of the present disclosure. In an embodiment, the fried, coated food product is a fried, coated French fry.

The following non-limiting examples are illustrative of the present disclosure:

### EXAMPLES

### General Experimental Details

I. Process

A pilot scale process based on a Stein pilot line was used in the studies of the present disclosure unless otherwise indicated below. Potatoes were placed in a rumbler, and excess skin was peeled by hand using a peeler. Potatoes were then cut with a pneumatic cutter to obtain potato strips having a ⅜ cut. The potato strips were blanched at 85° C. in 6 kg batches for a typical time of about 7-9 minutes. The blanched potato strips were then dipped at a temperature of 65° C. in a solution with a 1 wt % SAPP addition for a time of 1 minute. The blanched, dipped potato strips were then placed in a dryer at a temperature of 105° C. for a typical time of about 12-14 minutes to achieve a moisture loss of 8-10 wt % based on the total weight of the potato article or as otherwise noted in the discussion below.

The blanched, dipped, partially dried potato strips were enrobed in the batter being tested in a submerger belt enrober with a curtain overflow. The batter pick-up was checked, and blowers were used, if required. The batter pick-up was targeted at 12±1 wt % for the batter-coated potato strips of the present studies. A Stein APB was used for a set belt and fryer infeed belt. The batter-coated potato strips were fried in a one stage fryer, a Stein FA-5 (16″ line) in sunflower oil at a temperature of 185° C. for 30 seconds. The par-fried, coated potato strips were placed onto mesh racks, cooled and blast frozen to a temperature of −18° C. The frozen, par-fried, coated potato strips were reconstituted by frying and the fat content of the reconstitution-fried, coated potato strips was then analyzed using the method detailed below.

II. Starches

Table 1 details some of the properties of the following water-binding starches used in the present studies: Purity™ 87, Purity™ NCSA, Purity™ SCSA, National Frigex™ HV and Purity™ 4. PURITY NCSA and PURITY SCSA are acetylated di-starch phosphates of maize and waxy maize starches, respectively. The other starches are hydroxypropyl di-starch phosphates of tapioca starch.

TABLE 1
Selected properties of water-binding starches

| Brand | | Amylose | | Tolerance to |
|---|---|---|---|---|
| Name | Base | (wt %) | Modification(s) | Processing^{[2]} |
| PURITY 4 | tapioca | 17 | E1442: | moderate |
| | | | hydroxypropyl | |
| | | | di-starch | |
| | | | phosphate^{[1]} | |
| PURITY | tapioca | 17 | E1442: | high |
| | | | hydroxypropyl | |
| | | | di-starch | |
| | | | phosphate^{[1]} | |
| PURITY | maize | 25 | E1412: acetylated | high |
| NCSA | | | di-starch phosphate | |
| PURITY | waxy | <1 | E1412: acetylated | high |
| SCSA | maize | | di-starch phosphate | |
| NATIONAL | tapioca | 17 | E1442: | low-moderate |
| FRIGEX HV | | | hydroxypropyl | |
| | | | di-starch | |
| | | | phosphate^{[1]} | |

^{[1]}PURITY 4, PURITY 87 and NATIONAL FRIGEX HV have different levels of cross-linking.
^{[2]}Includes how tolerant the starch is to break down, shear, pH stability and temperature.

PURITY 4 is typically used in sauce applications, as it has a low hot viscosity, and is a fat mimetic which is typically used in dairy products. Starches having the modification type of PURITY 4 are commonly used for applications such as gravies, dips, sauces and fruit pie fillings, for example when a smooth, viscous, clear thickener with freeze-thaw stability would be useful.

Table 2 details some of the properties of the following high amylose maize starches that were used in the present studies: Crispfilm™ Hylon™ V, Hylon™ VII and Hylon™ VIII. CRISPFILM is a high amylose maize starch which has been chemically modified (stabilized) by acetylation. The other starches are native high amylose starches.

TABLE 2
Selected properties of high amylose maize starches

| Brand | | Amylose | | Tolerance to |
|---|---|---|---|---|
| Name | Base | (wt %) | Modification(s) | Processing^{[1]} |
| CRISPFILM | high amylose | 50 or 68 | E1420: | moderate |
| | maize | | acetylated | |
| | | | starch | |
| HYLON V | high amylose | 50 | none | high |
| | maize | | | |
| HYLON VII | high amylose | 70 | none | high |
| | maize | | | |
| HYLON | high amylose | 80 | none | high |
| VIII | maize | | | |

^{[1]}Includes how tolerant the starch is to break down, shear, pH stability and temperature.

The amylose contents reported for the starches are taken from a Brabender curve, where viscosity is plotted and moisture content adjusted accordingly, typically based on solids on a dry weight basis.

III. Batter Formulations

Chilled (5-10° C.) water was weighed out and placed into a Stein PBM mixer. The other ingredients were weighed out and blended together to obtain a batter powder. The batter powder was weighed out, placed into the mixer at a ratio of 1 part batter powder to 1.5 parts water, and the mixture was mixed on low shear for 5 minutes to obtain the batter. The batter solids and viscosity were checked. All solids were targeted at 36% and B6 viscosity targeted at 5-6 seconds. Solids were measured using a Sartorious which measures the actual solids percent in the slurry. The batter was then transferred to an enrober.

In addition to the starches as set out in the tables, the formulations contained: rice flour, 10-30%; salt, 7.4%; spice extract (turmeric extract), 0-5%; stabilizer (xanthan gum), 0-5%; color (paprika extract), 0-5%; and an anticaking agent (silicon dioxide)<1%. Certain batter formulations also contained fiber (potato and/or pea) as set out in the tables.

IV. Testing of Fat and Moisture Content

Par-fried, coated potato strips prepared in the present studies were frozen at a maximum temperature of −18° C. for at least 24 hours then fried in sunflower oil preheated to 175° C. for a time of 3 minutes in a fryer basket that was shaken under the oil twice, halfway through the time. The French fries obtained were placed onto a plastic tray, cooled for 10 minutes then frozen at a temperature of −18° C. for at least 24 hours. These steps were repeated until 5 batches of frozen French fries were obtained, then the 5 batches of frozen French fries were combined, ground in a mincer having a 3 mm screen, and returned to the freezer. The frozen French fries were defrosted prior to commencing analysis.

The fat content was analyzed using either the standard protocol for the Smart Trac Rapid Fat Analyzer manufactured by CEM or the standard Soxhlet process ISO 1442/1446. The moisture content was analyzed using the standard CEM protocol. Five replicates were tested for each sample. Samples tested had an average length specification of >80% >2″ and >20% >3″. Values for fat reduction in the tables are given in g/100 g (wt %) in relation to an internal control having a fat content of 11.55 g/100 g and optionally the actual control that was tested on the day of the trials listed in the table.

### Example 1

### Fat Content of French Fries Coated with Starch-Containing Batters

The process detailed above was used to study the various above-mentioned substituted, cross-linked starches and high amylose maize starches within batters used for coating finish-fried ⅜ cut French fries.

The water binding starches listed in Table 1 were screened initially before inclusion in the ratio trials (i.e. those trials in which the batter contained more than one type of starch) to study the effect on fat absorption of different modifications and/or botanical sources. These water-binding starches were then tested in combination with the high amylose maize starches listed in Table 2 in the ratios set out in Table 3. The fat reduction of French fries coated with such formulations are given in comparison to a fried, uncoated French fry having a fat content of 11.55 g/100 g.

TABLE 3

| | | | Fat Reduction vs. |
|---|---|---|---|
| Trial | Starch(es)^{[1]} | Ratio | Control 11.55 g/100 g (%) |
| 1 | CRISPFILM | 100 | 16.8 |
| 2 | HYLON VII | 100 | 19.9 |
| 3 | PURITY 4 | 100 | 19.9 |
| 4 | PURITY NCSA | 100 | 16.9 |
| 5 | PURITY SCSA | 100 | 20.3 |
| 6 | PURITY NCSA:CRISPFILM | 70:30 | 27.3 |
| 7 | PURITY SCSA:CRISPFILM | 70:30 | 25.5 |
| 8 | PURITY 4:CRISPFILM | 70:30 | 28.2 |
| 9 | PURITY NCSA:HYLON VII | 70:30 | 16.0 |
| 10 | PURITY SCSA:HYLON VII | 70:30 | 20.3 |
| 11 | PURITY 4:HYLON VII | 70:30 | 16.9 |

^{[1]}Trials conducted with CRISPFILM having an amylose content of 68 wt %.

The combination of a chemically modified tapioca starch and the chemically modified high amylose maize starch CRISPFILM was found to be the most consistent at reducing fat content; i.e. there was a low standard deviation between trials using this combination of starches.

The amount of the E1442 chemically modified tapioca starch PURITY 4 in batter formulations was also tested. The results (see Table 4) show that an amount of this starch greater than or equal to 70% in a batter formulation gave an increased amount of fat reduction than amounts less than 70% in a formulation in comparison to a fried, uncoated French fry control.

TABLE 4

| | | | | Fat Reduction |
|---|---|---|---|---|
| | | wt % | Fat Content | vs. Control^{[2]} |
| Trial | Starch | starch^{[1]} | (wt %) | 11.55 g/100 g (%) |
| 1 | PURITY 4 | 65 | 10.26 | 11.2 |
| 2 | PURITY 4 | 75 | 9.95 | 13.9 |
| 3 | PURITY 4 | 85 | 9.99 | 13.5 |

^{[1]}On a dry weight basis.
^{[2]}Fat content of control tested on the same day as trials 1-3 was 12.67 g/100 g.

Other ratios were studied (Table 5), taking into consideration their theoretical amylose contents to test on the bench an amylose and gel strength theory. While not wishing to be limited by theory, a greater fat reduction can demonstrate a greater gel-film has been formed.

TABLE 5

| | | Moisture | | Average Fat |
|---|---|---|---|---|
| Trial | Starches^{[1]} | (wt %) | Fat (wt %) | (wt %) |
| 1 | PURITY 4:CRISPFILM | 56.48 | 8.11 | 8.29 |
| | (70:30) | 54.73 | 8.47 | |
| 2 | PURITY 4:CRISPFILM | 58.57 | 7.23 | 7.23 |
| | (50:50) | 59.09 | 7.22 | |
| 3 | PURITY 4:CRISPFILM | 61.76 | 7.06 | 7.41 |
| | (30:70) | 59.72 | 7.76 | |
| 4 | PURITY 4:CRISPFILM | 51.40 | 10.11 | 9.61 |
| | (0:100) | 53.17 | 9.11 | |
| 5 | PURITY 4:CRISPFILM | 54.03 | 9.03 | 9.25 |
| | (100:0) | 53.16 | 9.46 | |

^{[1]}Trials conducted with CRISPFILM having an amylose content of 68 wt %.

PURITY 4 was then used in batters in combination with the different high amylose maize starches listed in Table 6 in a ratio of PURITY 4 to the high amylose maize starch of 70:30.

TABLE 6

| | | | Fat Reduction |
|---|---|---|---|
| | | Fat Content | vs. Control^{[2]} |
| Trial | Starches | (wt %) | 11.55 g (wt %) |
| 1 | PURITY 4:HYLON V | 11.0 | 4.8 |
| | (70:30) | | |
| 2 | PURITY 4:HYLON VII | 9.6 | 16.9 |
| | (70:30) | | |
| 3 | PURITY 4:HYLON VIII | 10.1 | 12.55 |
| | (70:30) | | |
| 4 | PURITY 4:CRISPFILM | 9.7 | 16.0 |
| | (70:30)^{[1]} | | |

^{[1]}CRISPFILM having an amylose content of 68 wt %.
^{[2]}Fat content of control tested on the same day as trials 1-4 was 14.30 g/100 g.

To study the results of using a chemically modified tapioca starch versus a chemically modified maize starch and a chemically modified waxy maize starch, the high amylose maize starches CRISPFILM and HYLON VII were used in the same ratio as the results listed in Table 6 to PURITY NCSA and PURITY SCSA. The results of these studies are detailed in Table 3.

The ratio of the chemically modified tapioca starch to CRISPFILM was then further studied against HYLON VII to investigate the strength of the amylose gels. A strong amylose gel is useful when trying to create a strong film that would stand up through a frying process such as the one described above which was used in the present studies. The higher the percentage of the high amylose starch such as CRISPFILM within these formulations, the higher the theoretical amylose content of the formulation (Table 7). The 70:30 ratio does not have the highest amylose content. However, there are other factors contributing to the strength of the film in a process which need to be considered and this appears to be a desired ratio for the times, temperature and limited water the product is subjected to in processes such as the one used in the present study.

TABLE 7

| | | | Amylose | | |
|---|---|---|---|---|---|
| | | | Content | Solids | Fat |
| Trial | Starches^{[1]} | Ratio | (wt %) | (wt %) | (g/100 g) |
| 1 | PURITY 4:CRISPFILM | 70:30 | 26.9 | 36.50 | 8.76 |
| 2 | PURITY 4:CRISPFILM | 60:40 | 30.2 | 36.60 | 8.53 |
| 3 | PURITY 4:CRISPFILM | 50:50 | 33.5 | 35.20 | 8.92 |
| 4 | PURITY 4:CRISPFILM | 40:60 | 36.8 | 37.30 | 7.37 |
| 5 | PURITY 4:CRISPFILM | 30:70 | 40.1 | 36.70 | 8.18 |
| 6 | PURITY 4:HYLON VII | 70:30 | 32.3 | 37.50 | 7.52 |
| 7 | PURITY 4:HYLON VII | 60:40 | 37.2 | 35.90 | 7.19 |
| 8 | PURITY 4:HYLON VII | 50:50 | 42.5 | 37.10 | 7.94 |
| 9 | PURITY 4:HYLON VII | 40:60 | 47.6 | 36.00 | 8.41 |
| 10 | PURITY 4:HYLON VII | 30:70 | 57.7 | 36.80 | 7.93 |
| 11 | PURITY 4:HYLON V | 70:30 | 26.9 | 36.80 | 8.18 |
| 12 | PURITY 4:HYLON V | 60:40 | 30.2 | 36.30 | 7.70 |
| 13 | PURITY 4:HYLON V | 50:50 | 33.5 | 37.10 | 7.85 |
| 14 | PURITY 4:HYLON V | 40:60 | 36.8 | 37.20 | 8.26 |
| 15 | PURITY 4:HYLON V | 30:70 | 40.1 | 37.30 | 9.64 |

^{[1]}Trials conducted with CRISPFILM having an amylose content of 50 wt %.

To study this, further bench trials were conducted using the chemically modified high amylose maize starch CRISPFILM (50% amylose and substituted with acetate) at the same percentages as previously studied and then using two other native high amylose starches, those being HYLON V (50% amylose) and HYLON VII (70% amylose). Both HYLON starches require a higher cook out temperature than CRISPFILM, peak gel temperatures being approximately 100° C. for HYLON V and 105° C. for HYLON VII. Table 7 details the results of these studies. Increasing amylose content was shown not to always have a positive effect on fat reduction from the trials conducted. For example, it was observed that increasing the amylose content past a specific point may have a negative effect on fat reduction. Lowering the tapioca starch percentage was shown to generally have a negative effect on fat reduction.

Various formulations were also tested to study the effect of varying the amount of moisture reduction in the drying step of the process which is subsequent to the dipping step. A dryer loss of 8-10% was found to be useful based on fat results as well as sensory qualities of the fried, coated French fries. The results of these studies are shown in Table 8.

TABLE 8

| | | Dry Loss | Process | Moisture | Fat |
|---|---|---|---|---|---|
| Trial | Starches^{[1]} | (wt %)^{[2]} | Method | (wt %) | (wt %) |
| control | — | 8% | 30 sec flash fry | 53.71 | 10.61 |
| | | | (185° C.) | 54.04 | 11.92 |
| 1 | PURITY 4:CRISPFILM | 8% | 30 sec flash fry | 57.18 | 7.62 |
| | (70:30) | | (185° C.) | 56.20 | 7.43 |
| 2 | PURITY 4:CRISPFILM | 10% | 30 sec flash fry | 58.20 | 7.88 |
| | (70:30) | | (185° C.) | 58.59 | 7.77 |
| 3 | PURITY 4:CRISPFILM | 15% | 30 sec flash fry | 55.80 | 8.66 |
| | (70:30) | | (185° C.) | 53.98 | 9.09 |
| 4 | PURITY 4:CRISPFILM | 20% | 30 sec flash fry | 53.96 | 8.04 |
| | (70:30) | | (185° C.) | 54.03 | 7.92 |

^{[1]}Trials conducted with CRISPFILM having an amylose content of 50 wt %.
^{[2]}In drying step subsequent to dipping step.

Overall, the most consistent results (i.e. results having a low standard deviation between trials) were observed to come from CRISPFILM in combination with the PURITY 4 in a ratio of PURITY 4 to CRISPFILM of 70:30.

Five large scale trials using formulations having a ratio of PURITY 4 to CRISPFILM of 70:30 were performed on a manufacturing line. The CRISPFILM had an amylose content of 50 wt %. Table 9 shows the average fat content of finish-fried ⅜ cut French fries and the standard deviation for each of the trials. The first three trials each had approximately 60 samples, the fourth trial had 10 samples, and the fifth trial had approximately 20 samples.

TABLE 9

| Trial | Average Fat (g/100 g) | Standard Deviation |
|---|---|---|
| 1 | 7.62 | 0.39 |
| 2 | 7.48 | 0.37 |
| 3 | 7.38 | 0.40 |
| 4 | 7.18 | 0.33 |
| 5 | 6.87 | 0.27 |
| Average: | 7.31 | 0.35 |

Each of the trials was very consistent. The fifth trial had a lower average fat than the other trials. The fifth trial used new potatoes, which have a different starch make-up. The length of the finished fries in the fifth trial was also longer than the other trials.

### Example 2

### Microscopy of Coated and Uncoated Fried French Fries

I. Osmium Staining

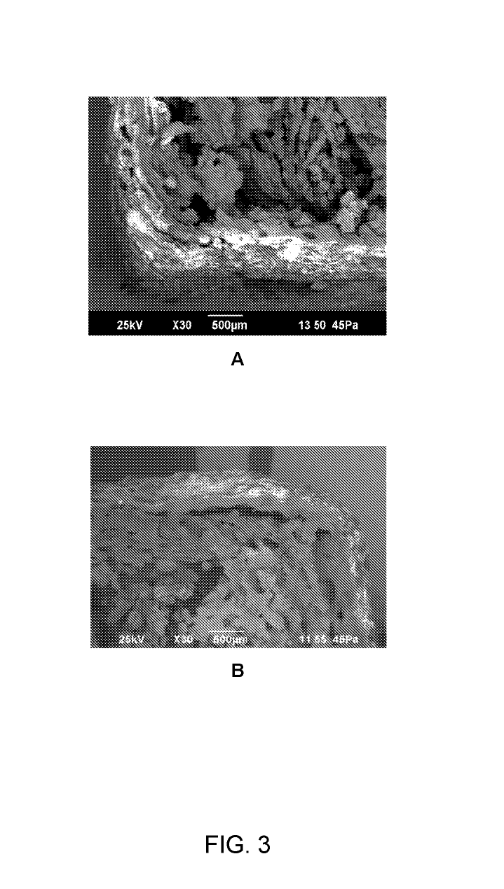

Exemplary osmium-stained images of cross-sections of a fried, uncoated French fry control and a fried, coated French fry comprising a hydroxypropylated, cross-linked tapioca starch (Purity 4) and an acetylated, high amylose maize starch (Crispfilm) in a ratio by weight of the hydroxypropylated, cross-linked tapioca starch to the acetylated, high amylose maize starch of about 70:30 are shown in FIG. 3A and FIG. 3B, respectively. The oil appears white in these images as a result of the osmium staining.

The uncoated control (FIG. 3A) shows a high percentage of oil penetrated through the coating and then into the first few cell layers of the potato. Damaged potato cells are also visible and oil would get into these very easily. In contrast, the image of the fried, coated French fry in FIG. 3B shows the minimal penetration of the oil. The oil is visible on the surface and not really penetrating into the batter or potato cells. The potato cells also appear less damaged than those of the fried, uncoated French fry control shown in FIG. 3A.

II. Confocal Microscopy

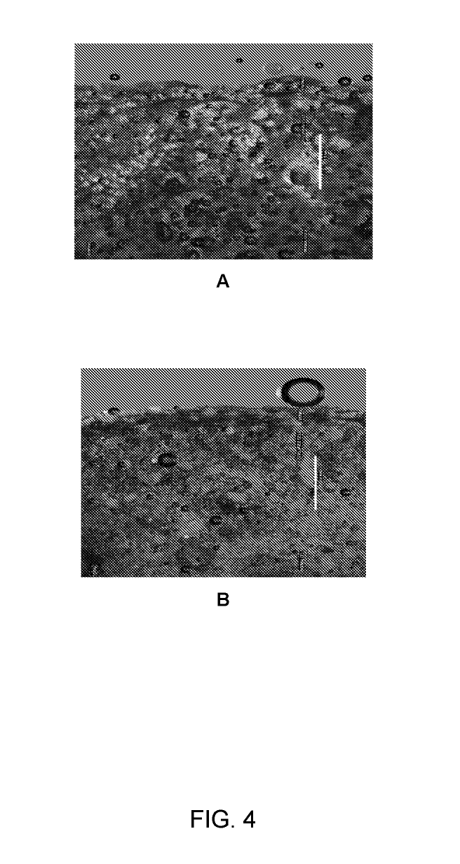

Exemplary confocal microscopy images of cross-sections of a fried, uncoated French fry control and a fried, coated French fry comprising a hydroxypropylated, cross-linked tapioca starch (Purity 4) and an acetylated, high amylose maize starch (Crispfilm) in a ratio by weight of the hydroxypropylated, cross-linked tapioca starch to the acetylated, high amylose maize starch of about 70:30 are shown in FIG. 4A and FIG. 4B, respectively. Nile red dye used for the confocal microscopy images highlights the oil as yellow in color images. However, the oil appears as light grey in the greyscale images of FIG. 4. The scale bar (white line) shown in FIG. 4A and FIG. 4B correlates to a length of 1.0 mm. The text located towards the right hand side of FIG. 4A and FIG. 4B, from bottom to top reads “normal cells”, “collapsed cells” and “coating”.

The level and depth of oil penetration is clear in both FIG. 4A and FIG. 4B. The depth of oil penetration is reduced dramatically in the fried, coated French fry shown in FIG. 4B in comparison to the fried, uncoated French fry control that is shown in FIG. 4A. The oil pools on the surface of the fried, coated French fry shown in FIG. 4B.

III. Stereomicrogragh Images

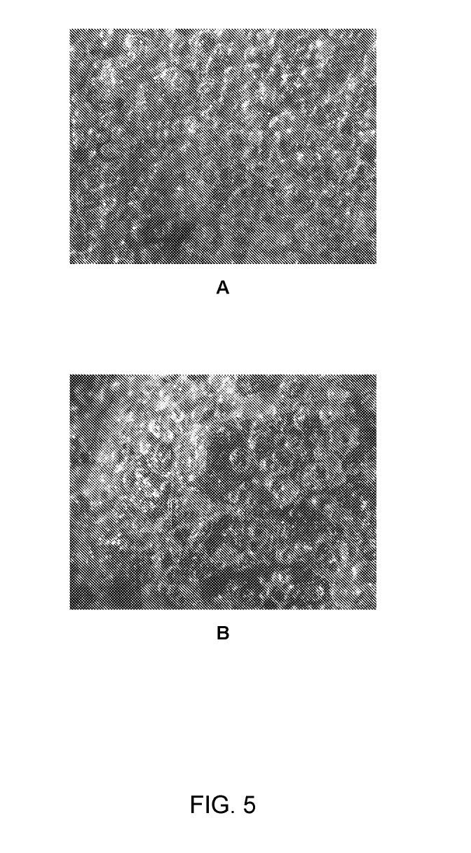

Exemplary stereomicrograph images of fried coatings comprising a hydroxypropylated, cross-linked tapioca starch (Purity 4) and an acetylated, high amylose maize starch (Crispfilm) in a ratio by weight of the hydroxypropylated, cross-linked tapioca starch to the acetylated, high amylose maize starch of about 70:30 and about 30:70 are shown in FIG. 5A and FIG. 5B, respectively.

The film having a 30:70 ratio between the hydroxypropylated, cross-linked tapioca starch and the acetylated, high amylose maize starch (FIG. 5B) shows larger air bubbles and pores, flared voids where large amounts of water has escaped. In contrast, the film having a 70:30 ratio between the hydroxypropylated, cross-linked tapioca starch and the acetylated, high amylose maize starch (FIG. 5A) shows small pores of even shape and size, indicating less moisture loss.

Water vapor escape from conventional battered food products typically causes discontinuities in batter films, such as large surface pores with flared voids that allow oil to permeate the batter into the food product. The continuous batter-coatings of the present disclosure have reduced permeability to oil. The continuous batter-coatings of the product and processes disclosed herein are typically substantially intact through frying, optionally through multiple frying stages and into a post cooking stage where the food products are held after cooking. The continuous surface optionally shows pores of substantially even shape and size under stereomicroscopy, typically with an absence of flared voids in the surface. Since the pores are small in the continuous surface, a majority of the oil present, by weight, for a particular French fry after removal from the fryer may pool on the surface of the French fry, or in the upper portion of the cooked batter surface, rather than with conventional batters where oil is substantially permeating the entirety of the batter through to the portion of the cooked batter proximate to the potato and into the potato itself.

IV. Hot Stage Microscopy Images

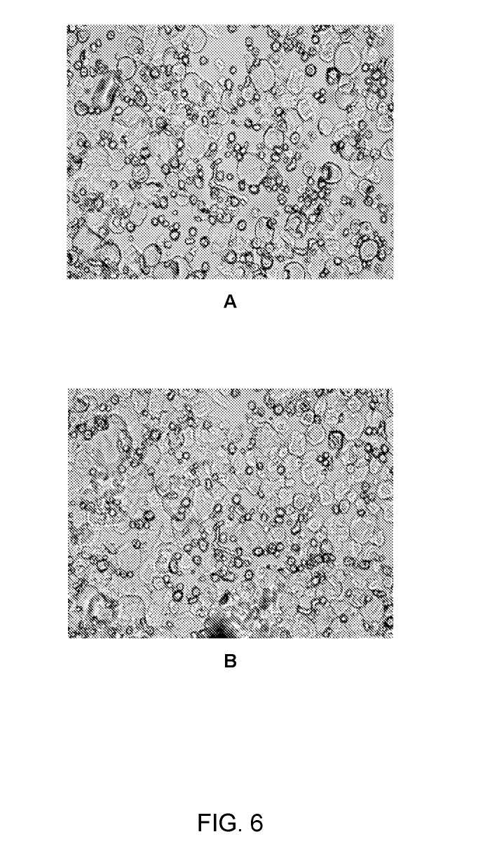

Exemplary hot stage microscopy images (10° C. per minute) are shown in FIG. 6A and FIG. 6B. Both hot stage images show a mixture comprising a hydroxypropylated, cross-linked tapioca starch (Purity 4) and an acetylated, high amylose maize starch (Crispfilm) in a ratio by weight of the hydroxypropylated, cross-linked tapioca starch to the acetylated, high amylose maize starch of about 70:30 in excess water. The formulation also includes rice flour, xanthan gum, colors and salt. The tapioca starch begins to swell at 55° C. and is shown in FIG. 6A as the swollen granules. The small, round granules shown in FIG. 6A are granules of the high amylose maize starch. The tapioca starch shows a larger swelling power at 80° C. and the high amylose maize starch shows minimal and restricted swelling (FIG. 6B). A continuous film is formed.

V. Working Theory

While not wishing to be limited by theory, a working theory has been developed for starch synergy and/or function in a step comprising par-frying a food product, for example a potato article such as a potato strip coated with an aqueous starch-containing batter of the present disclosure containing a water-binding starch, such as a hydroxypropylated, cross-linked starch, for example a tapioca starch, and a substituted high amylose maize starch. Water vapor kicks-in after 4-5 seconds of par-frying impacting, for example percent solids, oil temperature and pick-up. The water-binding starch such as a hydroxypropylated, cross-linked starch, for example a tapioca starch binds water and the substituted, high amylose maize starch sets down within the starch matrix in the first portion of the par-frying process. The water-binding starch continues to hold onto the water throughout the frying time of, for example about 30 seconds, controlling and avoiding its release, which inhibits oil penetration at this stage. For example, in a two stage frying process, the water-binding starch binds the moisture in the first stage of frying and continues to function in the second stage. The moisture loss profile (i.e. the manner in which the coating is dehydrated during heating and phase transition) of the starch-containing coating comprising these two starches goes from liquid to viscous to sticky and rubbery to partly dry and glassy but still functional throughout the par-frying time of, for example about 30 seconds.

### Example 3

### Fat Content of Fried French Fries Coated with Starch-Containing Batters Comprising a Tapioca Starch in Combination with a Native High Amylose Starch or a High Amylose Starch Blend

Batter formulations with starch blends having the different ratios of Purity 4 and the native high amylose maize starch Hylon VII (containing 70% amylose) shown in Table 10 were used to prepare fried, coated French fries. The batter formulation having a starch blend with a 40:60 ratio by weight of Purity 4:Hylon VII was used to prepare fried coated French fries having the lowest fat content in comparison to the other starch blends shown in Table 10.

TABLE 10
Fat Content of fried coated French fries prepared with batters
having different ratios of Purity 4 and Hylon VII.

| No. | Purity 4^{[1]} | Hylon VII^{[1]} | Fat (g/100 g) |
|---|---|---|---|
| 1 | 70 | 30 | 7.41 |
| 2 | 60 | 40 | 7.51 |
| 3 | 50 | 50 | 7.36 |
| 4 | 40 | 60 | 7.28 |
| 5 | 30 | 70 | 7.41 |

^{[1]}Values for each starch provided as wt % of total starch.

Batter formulations with the starch blends shown in Table 11 were used to prepare fried coated French fries. The batter formulation having a blend of starches with a 70:10:20 ratio by weight of Purity 4:Crispfilm (>68% amylose):Hylon VII was used to prepare fried coated French fries having the lowest fat content in comparison to the other starch blends shown in Table 11.

TABLE 11
Fat Content of fried coated French fries prepared with batters
having high amylose starch blends with different ratios of
Crispfilm and Hylon VII in combination with the tapioca
starch Purity 4.

| | | High Amylose Starch Blend | | |
|---|---|---|---|---|
| No. | Purity 4^{[1]} | Crispfilm^{[1]} | Hylon VII^{[1]} | Fat (g/100 g) |
| 1 | 60 | 30 | 10 | 7.86 |
| 2 | 60 | 20 | 20 | 8.32 |
| 3 | 60 | 10 | 30 | 8.09 |
| 4 | 70 | 20 | 10 | 8.13 |
| 5 | 70 | 15 | 15 | 7.64 |
| 6 | 70 | 10 | 20 | 7.56 |

^{[1]}Values for each starch provided as wt % of total starch.

The addition of an amount of native high amylose starch, which is sufficient enough to show a level of birefringence post par-fry corresponding to a useful amount of uncooked starch can create a homogenous batter film in the deep fry reconstitution cook, when used in combination with Purity 4 and/or Purity 87. A useful level of uncooked starch is such that the initial bound water released from the modified tapioca starch, Purity 4, is sufficient to ensure the function of the starch blend in the reconstitution cook phase.

### Example 4

### Fat Content of Fried French Fries Coated with Starch-Containing Batters Comprising a Tapioca Starch Blend and a High Amylose Starch

Batter formulations with the starch blends shown in Table 12 were used to prepare fried, coated French fries. Purity 87 is a more process tolerant tapioca-based hydroxypropylated di-starch phosphate than Purity 4. The batter formulation having a blend of starches with a 35:35:30 ratio by weight of Purity 4:Purity 87:Crispfilm (>68% amylose) was used to prepare fried coated French fries having the lowest fat content in comparison to the other starch blends shown in Table 12.

TABLE 12
Fat Content of fried coated French fries prepared with batters
having tapioca starch blends with different ratios of Purity 4
and Purity 87 in combination with the modified high amylose
starch Crispfilm.

| | Tapioca Starch Blend^{[1]} | | |
|---|---|---|---|
| No. | (Purity 4:Purity 87) | Crispfilm^{[1]} | Fat (g/100 g) |
| 1 | 70 (0:100) | 30 | 7.58 |
| 2 | 70 (90:10) | 30 | 7.36 |
| 3 | 70 (80:20) | 30 | 7.20 |
| 4 | 70 (70:30) | 30 | 7.40 |
| 5 | 70 (50:50) | 30 | 6.81 |

^{[1]}All batters have a 70:30 ratio of tapioca starch blend:Crispfilm. Values for each tapioca starch provided as wt % of tapioca starch blend.

The inclusion of a more process tolerant tapioca based hydroxylpropylated di-starch phosphate such as Purity 87 can provide useful starch swelling and granule integrity for creating a batter film to aid fat reduction.

Batter formulations with the starch blends shown in Table 13 were also used to prepare fried, coated French fries. National Frigex HV (NFHV) is a less process tolerant tapioca-based hydroxylpropylated di-starch phosphate than Purity 4. The batter formulation having a blend of starches at a ratio of 70 wt % water binding backbone starch (made up of 70 wt % Purity 4 and 30 wt % NFHV) to 30 wt % Crispfilm (>68% amylose) was used to prepare fried coated French fries having the lowest fat content in comparison to the other starch blends shown in Table 13.

TABLE 13
Fat Content of fried coated French fries prepared with batters
having tapioca starch blends with different ratios of Purity 4
and NFHV in combination with the modified high amylose
starch Crispfilm.

| | Tapioca Starch Blend^{[1]} | | |
|---|---|---|---|
| No. | (Purity 4:NFHV) | Crispfilm^{[1]} | Fat (g/100 g) |
| 1 | 70 (0:100) | 30 | 7.64 |
| 2 | 70 (90:10) | 30 | 7.81 |
| 3 | 70 (80:20) | 30 | 7.63 |
| 4 | 70 (70:30) | 30 | 7.49 |
| 5 | 70 (50:50) | 30 | 7.86 |

^{[1]}All batters have a 70:30 ratio of tapioca starch blend:Crispfilm. Values for each tapioca starch provided as wt % of tapioca starch blend.

The inclusion of a less process tolerant tapioca based hydroxylpropylated di-starch phosphate such as National Frigex HV (NFHV) can increase the maximum starch swelling and granule integrity would be decreased creating a batter film that is useful for fat reduction.

### Example 5

### Fat Content of Fried French Fries Coated with Starch-Containing Batters Comprising a Tapioca Starch Blend and a High Amylose Starch Blend

Batter formulations with the starch blends shown in Table 14 were used to prepare fried, coated French fries.

TABLE 14
Fat Content of fried coated French fries prepared with batters
having high amylose starch blends with different ratios of
Crispfilm and Hylon VII and a tapioca starch blend of
50:50 Purity 4:Purity 87.

| | Tapioca | | High Amylose | | |
|---|---|---|---|---|---|
| | Starch Blend | | Starch Blend | | |
| | Purity | Purity | | Hylon | Fat |
| No. | 4^{[1]} | 87^{[1]} | Crispfilm^{[1]} | VII^{[1]} | (g/100 g) |
| 1 | 35 | 35 | 30 | 0 | 6.81 |
| 2 | 35 | 35 | 15 | 15 | 7.52 |
| 3 | 35 | 35 | 20 | 10 | 7.85 |
| 4 | 35 | 35 | 10 | 20 | 7.30 |
| 5 | 35 | 35 | 0 | 30 | 7.32 |

^{[1]}Values for each starch provided as wt % of total starch.

Table 14 shows the effect of the addition of a native high amylose starch such as Hylon VII on the fat content of fried, coated French fries.

### Example 6

### Fried Coated French Fries Prepared with Batters Having Fiber

Batter formulations comprising a starch blend with a 70:30 ratio by weight of Purity 4:Crispfilm and the varying amounts of Roquette potato fiber and/or pea fiber I50M shown in Table 15 were used to prepare fried, coated French fries. Each of the batter formulations which was tested resulted in product having a lower fat content than a fried uncoated control French fry.

TABLE 15
Fat Content of fried coated French fries prepared
with batters comprising starch blends having a
70:30 ratio of Purity 4:Crispfilm and varying
amounts of pea and/or potato fiber.

| | | Trial No. 1 | | Trial No. 2 | |
|---|---|---|---|---|---|
| | | | % Fat | | % Fat |
| | | | reduction | | reduction |
| | | Fat | compared | Fat | compared |
| No. | Fiber | (g/100 g) | to control | (g/100 g) | to control |
| control | — | 11.55 | — | 11.55 | — |
| 1 | 0.5% pea | 6.94 | 39.9 | 7.41 | 35.8 |
| 2 | 2% potato | 7.00 | 39.3 | 7.11 | 38.4 |
| 3 | 2% pea + | 6.43 | 44.3 | 7.31 | 36.7 |
| | potato^{[1]} | | | | |
| 4 | 5% pea | 6.85 | 40.7 | 7.19 | 37.7 |
| 5 | 5% pea + | 6.85 | 40.7 | 7.41 | 35.8 |
| | potato^{[1]} | | | | |

^{[1]}50:50 ratio by weight pea fiber:potato fiber.

Batter formulations comprising a starch blend with a ratio by weight of 35:35:30 Purity 4:Purity 87:Crispfilm and the varying amounts of Roquette pea fiber I50M shown in Table 16 were used to prepare fried coated French fries. Each of these batter formulations resulted in product having a lower fat content than a fried uncoated control French fry.

TABLE 16
Fat Content of fried coated French fries prepared
with batters comprising starch blends having a
35:35:30 ratio of Purity 4:Purity 87:Crispfilm and
varying amounts of pea fiber.

| | | | % Fat reduction |
|---|---|---|---|
| No. | Fiber | Fat (g/100 g) | compared to control |
| control | — | 11.55 | — |
| 1 | 2% pea | 6.61 | 42.8 |
| 2 | 5% pea | 7.00 | 39.4 |

For the purpose of fat reduction in fried food products, the use of potato fibre and/or pea fibre in starchy batters was found to be useful. The addition of pea and/or potato fibre can increase moisture retention leading to increased fat reduction in deep fried coated food products.

### Example 7

### Comparison of Batters Having a Modified High Amylose Starch and Either a Single Tapioca Starch or a Tapioca Starch Blend

Images obtained after RVA analysis at a resolution of 640×512 and 10× magnification of a batter comprising a starch blend with a 35:35:30 ratio by weight of Purity 4:Purity 87:Crispfilm were compared to those of a batter having a 70:30 ratio by weight of Purity 4:Crispfilm. Images were also obtained using polarised light to observe the level of birefringence to indicate the amount of uncooked starch in the batter at this stage, a property which is useful to reducing fat in the final French fry reconstitution.

An increased coverage of starch volume was observed when a more process tolerant tapioca-based hydroxypropylated di-starch phosphate is added to the formulation. The batter comprising the tapioca starch blend (i.e. both Purity 4 and Purity 87) shows a more controlled and consistent granule swelling size when viewed after the RVA analysis in comparison to the batter comprising the single tapioca starch Purity 4. This is useful for creating a continuous barrier against fat absorption. The use of the more process tolerant starch Purity 87 in the batter also further increases the starch gelatinisation cascade in the deep fry reconstitution.

Having a more process tolerant modified tapioca starch in the batter such as Purity 87 can retain good granular structure and integrity through both frying stages which can produce a less homogenous film in process frying leading to a more stable film with less voids throughout reconstitution by enhancing C* (the Critical concentration of starch for optimum swelling capacity). Having different granule sizes can allow increased swelling power in the final batter and ghost remnants can increase overall batter stability which can reduce fat in French fries.

Having a more process tolerant modified tapioca starch in the batter such as Purity 87 forms a film that is useful to reduce fat uptake in deep fried foods such as French fries coated with such a batter as it maintains good granule integrity and structure which is useful to hold the starch ghost remnants in place post-gelatinisation to create a substantially continuous homogenous film that reduces the penetration of fat into the deep fried foods.

Hot stage microscopy can be used as an analytical tool to visualise the state of the starch at different times and temperatures as individual starches or within batter blends. A starch:water ratio of 1:1.75 is useful to demonstrate as closely as possible a low moisture system similar to the reality in the batters during rapid dehydration. A hot stage microscopy image obtained using a batter comprising a starch blend having a 35:35:30 ratio by weight of Purity 4:Purity 87:Crispfilm shows a continuous film was produced.

Nitrogen freezing of samples collected at various stages of the par-fry and reconstitution-fry allow for the visualization of the cascade of starch gelatinisation in the batters using polarised light microscopy. This can be used, for example, for screening the success of a batter for reducing fat uptake in fried, coated food products.

Nitrogen freezing used in conjunction with light and polarised light microscopy was used to view the degree of starch cook out during fryer reconstitution (3 minutes cook time at 175° C. in sunflower oil) for the batter comprising a starch blend having a 70:30 ratio of Purity 4:Crispfilm. After 10 seconds, a high level of uncooked starch is present. The batter is observed to be unhomogenous, with large levels of birefringence. While not wishing to be limited by theory, this property is what gives the batter its function through the frying. After 1 minute and 30 seconds, the batter film is beginning to look more homogenous as starch begins to gelatinise. The melting of the crystallinity is observed as well as a higher level of cooked starch. However, there are still areas of uncooked starch. This level of uncooked starch is useful to function in the remaining cook time. After three minutes, (i.e. at the end of the fry time) the batter film is more homogenous and gel-like. A high level of gelatinised starch is seen by the low level of birefringence being observed.

Nitrogen freezing was also used in conjunction with light and polarised light microscopy to view the degree of starch cook out during fryer reconstitution (3 minutes cook time at 175° C. in sunflower oil) for the batter comprising a starch blend having a 35:35:30 ratio by weight of Purity 4:Purity 87:Crispfilm. After 10 seconds, small clusters of uncooked starch were observed using polarised light microscopy. The coating appeared to be dough-like and elastic with a smooth and glossy appearance. The coating appeared to be demonstrating placidity as it was more cooked out. After 1 minute and 30 seconds, the coating was well-adhered to the substrate. The starch in the coating was more cooked out; it still showed amorphous regions but the majority of the starch is cooked out as was seen under the polarised light, where strained birefringence shows the melting of the crystals. The potato cells below the batter showed signs of dehydration and compacting as they collapsed, leaving a void. This is where the batter can pull away from the retracting potato cells. Starch ghosts could be seen in the coating and the process tolerance of Purity 87 led to these ghosts being still intact to support the cooked matrix of the film.

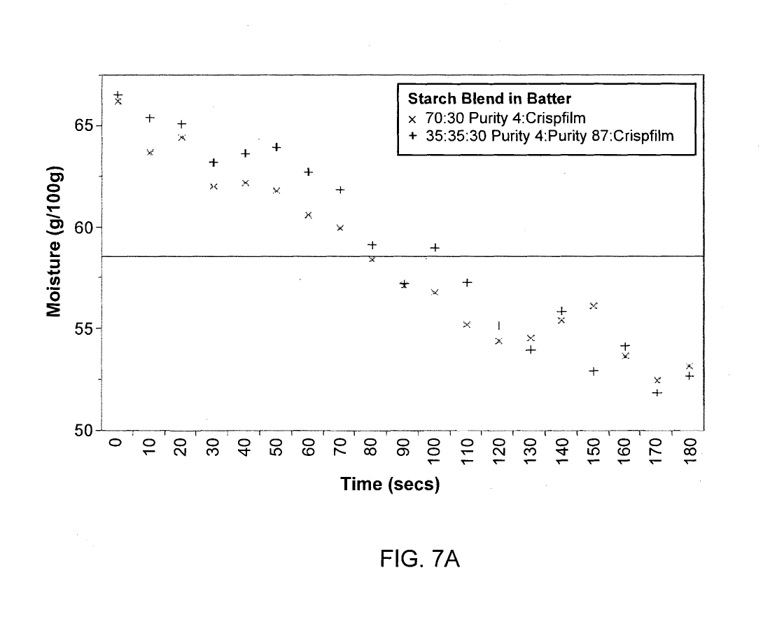

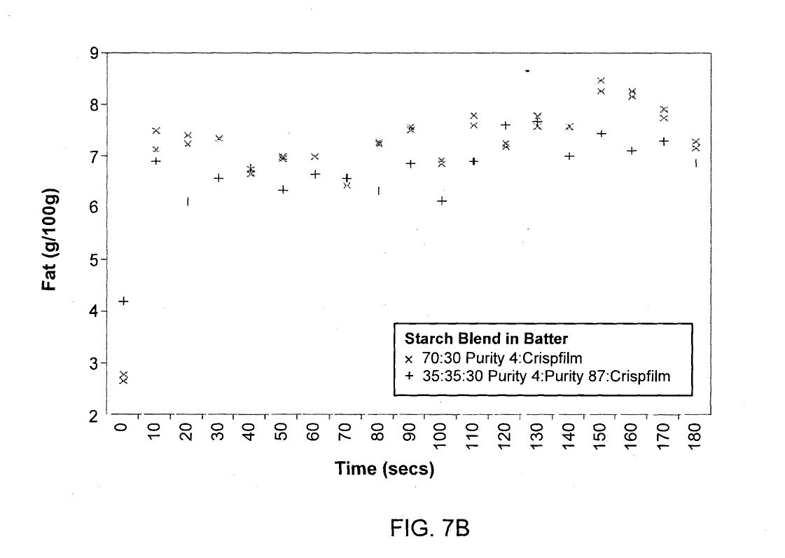

The moisture loss of the product throughout the reconstitution cook time was used in combination with CEM Smart Trac Rapid fat analysis to analyze the fat content throughout the reconstitution cook time (FIG. 7). These models show the use of the coating to limit moisture loss from the potato and hence limit fat uptake. Typically, the higher the moisture the lower the total fat content of the product. The film of the batter comprising a starch blend having a 35:35:30 ratio by weight of Purity 4:Purity 87:Crispfilm has a greater ability to withstand moisture loss than a film of the batter comprising a starch blend having a 70:30 ratio of Purity 4:Crispfilm (FIG. 7). Samples were tested every 10 seconds throughout the reconstitution cook time (total time of 3 minutes at a temperature of 175° C.) n=18.

### Example 8

### Breakdown:Peak (B:P) Ratio for E1442 Tapioca Starches

I. Rapid Visco Analyser (RVA) Methodology

Newport Scientific RVA ‘Standard 1’ profile. Samples were weighed into RVA aluminium sample canisters at 14.3% on a wet basis (i.e. 4 g sample+24 g deionised water). The total sample weight for each sample was 28 g±0.01 g. Measurements were carried out within 1 minute of hydrating the samples. The ‘Standard 1’ profile had an initial stirring rate at 960 RPM for 10 seconds followed by constant stirring rate at 160 RPM for 13 minutes. For the first minute, the sample was held at 50° C. followed by gradual heating to 95° C. over 3 minutes and 42 seconds (heating rate of 11.25° C.·min⁻¹). It was then held at 95° C. for 2 minutes 30 seconds and gradually cooled down to 50° C. over 3 minutes and 48 seconds (cooling rate of 11.25° C.·min⁻¹). Finally, the sample was held at 50° C. for 2 minutes. The total test duration was 13 minutes with 4-second intervals between readings.

II. Results and Discussion

The Breakdown:Peak (B:P) ratio is an indicator of the amount that a starch collapses under constant shear/temperature conditions, relative to its RVA peak viscosity. The B:P ratio may present advantages over fundamental techniques, as it is dependent on the application. The B:P ratios obtained for three tapioca-based hydroxypropyl di-starch phosphates is shown in Table 17. Typically, a lower B:P ratio indicates a higher level of process tolerance.

TABLE 17

| Starch | B:P ratio^{[1]} |
|---|---|
| Purity 87 | 0.18-0.22 |
| Purity 4 | 0.34-0.43 |
| National Frigex HV | 0.38-0.42 |

^{[1]}Based on 14.3 wt % solids on a wet basis.

This is a novel technique which has been used for this range of E1442 tapioca starches. The comparisons are based on the assumption that modifications (i.e. substitution) are consistent across samples.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

1. An aqueous composition for coating a food product, the aqueous composition comprising:
a hydroxypropylated, cross-linked tapioca starch; and
an acetylated, high amylose maize starch,
wherein the hydroxypropylated, cross-linked tapioca starch is a hydroxypropyl di-starch phosphate.

2. The aqueous composition of claim 1, further comprising xanthan gum.

3. The aqueous composition of claim 2, further comprising rice flour.

4. The aqueous composition of claim 3, further comprising salt.

5. The aqueous composition of claim 4, further comprising at least one coloring agent.

6. The aqueous composition of claim 1, wherein the food product is a fried, coated vegetable article.

7. The aqueous composition of claim 10, wherein the fried, coated potato article is a fried, coated French fry.

8. The aqueous composition of claim 7, wherein the fried, coated French fry is a fried, coated shoestring French fry or a fried, coated square cut French fry.

9. The aqueous composition of claim 8, wherein the fried, coated square cut French fry is a fried, coated ⅜ inch cut French fry.

10. The aqueous composition of claim 6, wherein the fried, coated vegetable article is a fried, coated potato article.

11. The aqueous composition of claim 10, wherein the fried, coated potato article is a fried, coated sweet potato fry.

12. A process for preparing fried, coated food products, the process comprising:
coating food products with an aqueous starch-containing batter comprising an aqueous composition of claim 1 to obtain batter-coated food products; and
frying the batter-coated food products to obtain the fried, coated food products.

13. The process of claim 12, wherein the process is a process for preparing fried, coated vegetable articles, the process comprising:
coating blanched vegetable articles with the aqueous starch-containing batter to obtain batter-coated vegetable articles; and
frying the batter-coated vegetable articles to obtain the fried, coated vegetable articles.

14. The process of claim 13, wherein the vegetable articles are potato articles.

15. The process of claim 14, wherein the blanched potato articles are prepared by a process comprising:
blanching potato articles under conditions to obtain freshly blanched potato articles;
dipping the freshly blanched potato articles in a solution that inhibits discoloration of the blanched potato articles to obtain blanched, dipped potato articles; and
partially drying the blanched, dipped potato articles under conditions to obtain a moisture reduction of from about 8 wt % to about 10 wt % in the freshly blanched potato articles to obtain the blanched potato articles.

16. The process of claim 15, wherein the process is for preparing a fried, coated French fry.

17. The process of claim 15, wherein the process is for preparing a fried, coated sweet potato fry.

18. A fried, coated food product prepared according to the process of claim 12.

19. The fried, coated food product of claim 18, which is a fried, coated French fry.

20. The fried, coated food product of claim 18, which is a fried, coated sweet potato fry.
